(19) United States
(12) Patent Application Publication
(10) Pub. No.: US 2026/0316054 A1
(43) Pub. Date: Oct. 15, 2026

(54) METHODS OF PRODUCING AND RECYCLING FUNCTIONALIZED AGGLOMERATED SILICA

(71) Applicant: X Development LLC, Mountain View, CA (US)

(72) Inventors: Zoanne ZWEBER, San Francisco, CA (US); Chaokun GONG, Sunnyvale, CA (US); Jeremy Aaron WILLMAN, Redwood City, CA (US); Kevin Wayne SEYBERT, San Francisco, CA (US); Jacques GAGNE, Los Gatos, CA (US)

(21) Appl. No.: 19/484,310

(22) PCT Filed: May 23, 2024
(86) PCT No.: PCT/US2024/030855

§ 371 Date: Nov. 13, 2025

Related U.S. Application Data
(60) Provisional application No. 63/468,443, filed on May 23, 2023.

(51) Int. Cl. B01J 20/30; B01D 53/04; B01J 20/10; B01J 20/22; B01J 20/28; B01J 20/32; B01J 20/34

(52) U.S. Cl. CPC B01J 20/3028; B01D 53/0446; B01J 20/103; B01J 20/22; B01J 20/28004; B01J 20/28011; B01J 20/28016; B01J 20/2803; B01J 20/28071; B01J 20/28073; B01J 20/28076; B01J 20/28083; B01J 20/28085; B01J 20/3042; B01J 20/3078; B01J 20/3204; B01J 20/3257; B01J 20/3289; B01J 20/3483; B01D 2253/106; B01D 2253/20; B01D 2253/25; B01D 2257/504; B01D 2258/06; B01D 2259/40088

(57) ABSTRACT

Disclosed herein is a functionalized granule including a plurality of fine particles and a coating, as well as systems configured to employ such functionalized granules. Also disclosed herein is a method including collecting a plurality of fine particles; and generating a plurality of functionalized granules using the plurality of fine particles, wherein an average dimension or a mean dimension of the plurality of functionalized granules is larger than an average dimension or a mean dimension of the plurality of fine particles.

### CROSS-REFERENCE TO RELATED APPLICATION

This application claims the benefit of U.S. Provisional Application 63/468,443 filed May 23, 2023, the disclosure of which is incorporated herein by reference.

### FIELD OF THE DISCLOSURE

The disclosure relates to a functionalized granule and, more specifically, to a functionalized granule that can include porous silica and that can be used for reversibly capturing a gas (e.g., carbon dioxide).

### BACKGROUND

Atmospheric carbon concentrations have risen in correlation with industrialized activity for decades. Carbon dioxide is a primary contributor to the total carbon concentration. Three-dimensional porous structures can be used to remove carbon dioxide from gaseous environments.

### SUMMARY

In general, the disclosure relates to a method of collecting fine particles and then further processing such fine particles (e.g., by agglomerating and regenerating the fines into larger particles, such as granules). Particle-based sorbents can be used in carbon capture systems, in which fine particles can be generated through the movement of sorbents in the system or other processing equipment. Depending on the composition of the sorbent, varying levels of particle attrition can occur, leading to the generation of fine particles (or fines).

Fines can be derived from larger functionalized silica particles, and then the fines themselves (e.g., functionalized silica fines) can be processed to provide larger particles (e.g., a functionalized granule, as described herein). In some embodiments, the granule is a functionalized granule having a coating and/or a matrix configured for gas capture (e.g., CO₂ capture). In particular embodiments, the granules can be generated for the purpose of reversibly capturing carbon dioxide at low concentrations (e.g., <400 ppm, atmospheric concentrations) from a gas (e.g., ambient air).

Larger particles, such as granules, can include functionalization. In some embodiments, fines can be agglomerated to form granules, and then the granules can be functionalized to include a coating or a matrix. In other embodiments, the fines can be processed to form functionalized fines having a coating or a matrix, and then the functionalized fines can be agglomerated to form granules (e.g., functionalized granules). A coating or a matrix can be present on a surface (e.g., on at least a portion of a surface for a fine or for a granule) or between surfaces (e.g., between at least a portion of a plurality of fines or a plurality of granules).

Functionalization can include the use of an amine-containing compound (e.g., a polymeric amine and/or an aminosilane) within a coating and/or a matrix. Functionalization can be employed with fines or granules. In some embodiments, porous silica fines or porous silica granules can be functionalized with a polymeric amine, such as polyethylenimine (PEI), and an aminosilane containing at least one silane moiety and at least one amine moiety. Non-limiting examples of aminosilanes include an aminoalkyl-substituted trialkyoxysilane (e.g., N-(2-aminoethyl)-3-aminopropyltrimethoxysilane)). In some embodiments, porous silica fines or porous silica granules can feature large pore sizes and high surface-to-volume ratios. In some examples, the fine particles making up the granules are re-coated with a functionalization mixture (e.g., a mixture of a polymeric amine and an aminosilane), which can provide a CO₂-capture capacity of the granules that is comparable to or even above the capture capacity of the ‘fresh’ adsorbent from which the fine particles were formed. In more examples, the granules can have comparable or even higher mechanical strength than the ‘fresh’ adsorbent, which can depend on various factors (e.g., on the stage at which the functionalization mixture is applied to the fine particles during agglomeration or applied to the granules once the fines are agglomerated; on the type of amine-containing compounds and/or binders using during agglomeration; on shear force applied during agglomeration, etc.).

Without wishing to be limited by mechanism, the combination of a polymeric amine and an aminosilane can increase the number of amine moieties that are accessible for carbon capture. In some embodiments, the agglomeration and coating methods can facilitate scaled-up sorbent regeneration and recycling of some reagents, which can reduce long-term production costs. In some embodiments, the regeneration method reduces energy, materials, and time for producing new sorbents to replace that lost to attrition. In yet other embodiments, the regeneration method produces strengthened sorbent and reduces damage to regenerated silica particles.

In general, the disclosure relates to methods of recycling depleted sorbent. The adsorptive capacity of the sorbent may be reduced below a useful threshold following multiple cycles of adsorption and desorption. Recycling depleted sorbent reduces the environmental impact of depleted sorbent produced by carbon capture processes. The recycling methods can be performed at scale to reduce long-term recycling costs. Example methods of recycling the depleted sorbent include regeneration, repurposing, or passivation.

Regeneration methods reduce the energy, material, and time costs for producing new sorbent from depleted sorbent. The regeneration methods include calcination, amine regeneration, or amine reduction. Each regeneration method produces raw materials for new sorbents for further functionalization.

Repurposing methods reduce the environmental impact of depleted sorbent by integrating the depleted sorbent into a different industrial process. The depleted sorbent is thus diverted from waste streams and directed to productive processes thereby reducing overall waste generated by the carbon capture process.

Passivation methods reduce the environmental impact of depleted sorbent by chemically pacifying amine groups present on the depleted sorbent. Chemical passivation reduces the reaction potential of the depleted sorbent and reduces the cost and energy associated with specialized handling and disposal of the depleted sorbent.

In general, an aspect disclosed herein is a functionalized granule including a plurality of fine particles, wherein at least one of the plurality of fine particles includes a first porous silica, a first silane moiety bound to a surface of the first porous silica, and a first amine moiety bound to the first silane moiety; and a coating disposed on at least a portion of a surface of at least one of the plurality of fine particles, wherein the coating includes an optional second silane moiety and a second amine moiety, and optionally wherein the coating is configured to bind the plurality of fine particles.

In some embodiments, at least one of the plurality of fine particles includes: a first porous silica, a first silane moiety bound to a surface of the first porous silica, and a first amine moiety bound to the first silane moiety.

In some embodiments, the coating includes an optional second silane moiety and a second amine moiety. In some embodiments, the coating is configured to bind the plurality of fine particles. In some embodiments, the coating includes the second silane moiety, and the second amine moiety is bound to the second silane moiety. In some embodiments, the coating is disposed on surfaces of the plurality of fine particles. In some embodiments, the first and second silane moieties may be the same or different. In some embodiments, the first and second amine moieties may be the same or different.

In some embodiments, the functionalized granule further includes a matrix. In some embodiments, the matrix disposed between at least a portion of the plurality of fine particles. In some embodiments, the matrix includes the second silane moiety and the second amine moiety.

In some embodiments, the coating and/or the matrix, if present, further includes a polymer (e.g., a polymeric amine).

In another aspect, the present disclosure encompasses a method including: collecting a plurality of fine particles, wherein at least one of the plurality of fine particles comprises a first porous silica, a first silane moiety bound to a surface of the first porous silica, and a first amine moiety bound to the first silane moiety; and generating a plurality of functionalized granules using the plurality of fine particles, wherein an average dimension or a mean dimension (e.g., diameter) of the plurality of functionalized granules is larger than an average dimension or a mean dimension (e.g., diameter) of the plurality of fine particles, and optionally wherein at least one of the plurality of functionalized granules comprises a second porous silica, a second silane moiety bound to the surface of the second porous silica, and a second amine moiety bound to the second silane moiety.

In some embodiments (e.g., of any aspect herein), an average dimension or a mean dimension (e.g., diameter) of the plurality of functionalized granules is larger than an average dimension or a mean dimension (e.g., diameter) of the plurality of fine particles.

In some embodiments (e.g., of any aspect herein), at least one of the plurality of fine particles includes: a first porous silica, a first silane moiety bound to a surface of the first porous silica, and a first amine moiety bound to the first silane moiety

In some embodiments (e.g., of any aspect herein), at least one of the plurality of functionalized granules includes: a second porous silica, a second silane moiety bound to the surface of the second porous silica, and a second amine moiety bound to the second silane moiety.

In some embodiments, said generating includes: agglomerating the plurality of fine particles to provide a plurality of granules; and forming a coating on at least a portion of a surface of at least one of the plurality of granules and/or a matrix between at least a portion of the plurality of fine particles or between at least a portion of the plurality of granules, thereby generating the plurality of functionalized granules.

In some embodiments, said generating includes forming a coating on at least a portion of a surface of at least one of the plurality of fine particles and/or a matrix between at least a portion of the plurality of fine particles, thereby providing a plurality of functionalized fine particles; and agglomerating the plurality of functionalized fine particles, thereby generating the plurality of functionalized granules.

In some embodiments, said generating includes exposing the plurality of fine particles, the plurality of granules (if present), or the plurality of functionalized fine particles (if present), to a liquid binder.

In some embodiments, said generating includes spraying the plurality of fine particles, the plurality of granules (if present), or the plurality of functionalized fine particles (if present), with a liquid binder.

In some embodiments, said generating includes applying shear to the plurality of fine particles, the plurality of granules (if present), or the plurality of functionalized fine particles (if present).

In some embodiments, said collecting includes obtaining the plurality of fine particles from an inlet to a reactor including a powdered adsorbent material or an outlet from a reactor including a powdered adsorbent material (e.g., an adsorption reactor, a desorption reactor, or another reactor). In some embodiments, the powdered adsorbent material includes the first porous silica, the first silane moiety bound to a surface of the first porous silica, and/or the first amine moiety bound to the first silane moiety.

In some embodiments, the second porous silica of at least one of the plurality of functionalized granules includes the first porous silica of at least one of the plurality of fine particles.

In some embodiments, the method further includes drying said plurality of functionalized granules (e.g., in a vacuum oven at 80° C. until a hydration threshold of less than 5% wt/wt of water to coated silica substrate is reached).

In another aspect, the present disclosure encompasses a direct air capture (DAC) system configured to employ a functionalized granule. In some embodiments, the system includes: a first inlet configured to receive a first powdered adsorbent material; a second inlet configured to receive a recycled powdered adsorbent material obtained by recycling at least a portion of the first powdered adsorbent material; an adsorber system configured to adsorb CO₂ from ambient air using the first powdered adsorbent material and the recycled powdered adsorbent material; a desorber system configured desorb to CO₂ from the first powdered adsorbent material and the recycled powdered adsorbent material; and an outlet configured to deliver a plurality of fine particles from a volume of air passaged into, through, or out of the adsorber system.

In some embodiments, the first powdered adsorbent material includes a plurality of first functionalized granules, wherein at least one of the plurality of first functionalized granules includes a first porous silica, a first silane moiety bound to a surface of the first porous silica, and a first amine moiety bound to the first silane moiety.

In some embodiments, at least one of the plurality of fine particles includes the first porous silica, the first silane moiety bound to a surface of the first porous silica, and/or the first amine moiety bound to the first silane moiety from at least one of the plurality of first functionalized granules.

In some embodiments, the recycled powdered adsorbent material includes a plurality of second functionalized granules, wherein at least one of the plurality of second functionalized granules includes a second porous silica, a second silane moiety bound to the surface of the second porous silica, and a second amine moiety bound to the second silane moiety.

In some embodiments, the second porous silica of at least one of the plurality of second functionalized granules includes the first porous silica of at least one of the plurality of fine particles or the first porous silica of at least one of the plurality of first functionalized granules.

In some embodiments, the system further includes: one or more blowers each arranged to receive ambient air and blow air into the adsorber system; and one or more exhaust ports each configured to remove air from the adsorber system and/or the desorber system. In some embodiments, the outlet is in fluidic communication with at least one of the one or more exhaust ports.

In yet another aspect, the present disclosure encompasses an agglomeration system configured to provide a functionalized granule. In some embodiments, the system includes: a first inlet configured to receive a plurality of fine particles, wherein at least one of the plurality of fine particles includes a first porous silica, a first silane moiety bound to a surface of the first porous silica, and a first amine moiety bound to the first silane moiety; a second inlet configured to a liquid binder; a reactor configured to generate a plurality of functionalized granules using the plurality of fine particles, wherein an average dimension or a mean dimension (e.g., diameter) of the plurality of functionalized granules is larger than an average dimension or a mean dimension (e.g., diameter) of the plurality of fine particles; and an outlet configured to deliver the plurality of functionalized granules out of the reactor.

In some embodiments, the second porous silica of at least one of the plurality of functionalized granules includes the first porous silica of at least one of the plurality of fine particles.

In some embodiments, said reactor includes: a liquid handler (e.g., a sprayer) configured to expose the plurality of fine particles to a liquid binder (e.g., any described herein).

In some embodiments, said reactor includes: a mixer configured to apply shear to the plurality of fine particles. Non-limiting mixers include a pin mixer, a paddle mixer, and/or a ribbon blender.

In any embodiment herein, the plurality of fine particles has an average dimension or a mean dimension (e.g., diameter) of about 25 microns to about 500 microns.

In any embodiment herein, at least one fine particle of the plurality of fine particles includes a plurality of pores. In some embodiments, the plurality of pores has an average dimension or a mean dimension (e.g., diameter) of about 60 angstroms to about 600 angstroms and/or a pore volume of about 0.1 mL/g to about 2.0 mL/g (e.g., about 0.5 mL/g).

In any embodiment herein, the functionalized granule has an average dimension or a mean dimension (e.g., diameter) of about 500 microns to about 2 millimeters.

In any embodiment herein, the functionalized granule includes a plurality of pores.

In any embodiment herein, the functionalized granule is characterized by a bulk density of about 10 lb/ft³ to about 40 lb/ft³ (e.g., about 15 lb/ft³ or about 30 lb/ft³), an average pore size of about 60 angstroms to about 600 angstroms; and/or a pore volume of about 0.1 mL/g to about 2.0 mL/g (e.g., about 0.5 mL/g).

In general, an aspect disclosed herein is a method of making calcined particles. The method includes collecting a plurality of depleted functionalized particles, where the plurality of depleted functionalized particles may include a porous silica, a silane moiety bound to a surface of the porous silica, and an amine moiety bound to the silane moiety; and heating the plurality of depleted functionalized particles to a temperature sufficient to thermally decompose the silane moiety and the amine moiety to generate a plurality of calcined particles.

Examples may include one or more of the following features.

In any embodiment herein, the plurality of depleted functionalized particles can have a CO₂ uptake capacity of less than 0.5 mol CO₂/kg.

In any embodiment herein, the temperature can be sufficient to prevent crystallization of the plurality of depleted functionalized particles.

In any embodiment herein, the method may include maintaining the temperature for a duration sufficient to thermally decompose the silane moiety and the amine moiety.

In any embodiment herein, the method may include cooling, after the duration, the calcined particles at a rate sufficient to prevent crystallization of the calcined particles.

In any embodiment herein, the heating, the cooling, or both, are performed independently for a duration that can be no more than one hour each.

In any embodiment herein, the method may include providing at least a portion of the calcined particles as the plurality of fine particles in the method.

In general, an aspect disclosed herein is a method including collecting a plurality of depleted functionalized particles, where the plurality of depleted functionalized particles may include a porous silica, a silane moiety bound to a surface of the porous silica, and an amine moiety bound to the silane moiety; and exposing the plurality of depleted functionalized particles to a pacification agent such that a plurality of depleted functionalized particles are no longer reactive.

Examples may include one or more of the following features.

In any embodiment herein, the method where exposing may include exposing the plurality of depleted functionalized particles to a reducing agent which chemically reduces the amine moiety.

In any embodiment herein, the method may include providing at least a portion of the porous silica as the plurality of fine particles in the method.

In any embodiment herein, exposing may include exposing the plurality of depleted functionalized particles to an oxidizing agent which chemically reduces the amine moiety and the silane moiety.

In any embodiment herein, exposing may include exposing the plurality of depleted functionalized particles to a conversion agent such that the amine moiety can be converted to a nitrogen source.

In any embodiment herein, the nitrogen source can be a urea-containing nitrogen source.

In any embodiment herein, the conversion agent can be carbon dioxide or formaldehyde.

In any embodiment herein, the method may include drying, before exposing, the plurality of depleted functionalized particles to a moisture content of 5% wt/wt or less.

In any embodiment herein, exposing may include exposing the plurality of depleted functionalized particles to one or more polar solvents sufficient to remove the amine moiety and the silane moiety from the porous silica.

In any embodiment herein, exposing may include exposing the plurality of depleted functionalized particles to a first aqueous solution of about pH 2 or less, and a second aqueous solution of pH 12 or greater, where the pH can be sufficient to remove the amine moiety and the silane moiety from the porous silica.

Particular, non-limiting implementations of the subject matter described in this specification can be implemented so as to realize one or more of the following technical advantages.

The regenerated silica can be produced in a water-based, single-pot reaction at ambient pressures and temperatures in short time scales, thereby reducing the cost of production, reducing reliance on industrial solvents, and/or reducing the environmental impact of the product.

The regenerated silica can adsorb CO₂ at concentrations similar to freshly produced silica sorbents, enabling efficient capture at levels present in atmospheric conditions using recycled products. Capturing CO₂ from atmospheric conditions can facilitate employing the regenerated silica in a large number of applications.

CO₂ can be desorbed from the regenerated silica at laboratory temperatures, which can reduce the energy required to remove captured CO₂, increase the applicability of the regenerated silica to more industries and environments, and/or increase the speed at which the CO₂ is desorbed.

The regenerated silica can achieve high adsorption/desorption counts, which reduces operational costs in carbon capture systems.

The regenerated silica can be produced using industrially available components, thereby reducing the cost of and increasing the scalability of production.

Regenerating silica fines with a polymeric compound can increase the binding stability and mechanical strength of the agglomerated particles, thereby increasing the useful lifespan of the regenerated silica.

The details of one or more embodiments are set forth in the accompanying drawings and the description below. Other features and advantages will be apparent from the description and drawings, and from the claims.

### DESCRIPTION OF DRAWINGS

FIG. 1 is a schematic illustration of a functionalized granule.

FIGS. 2A-2K are chemical illustrations of exemplary compounds including silane groups, amine groups, and polymeric amine groups.

FIG. 3A is a flow chart diagram showing non-limiting steps of producing functionalized granules from fine particles.

FIG. 3B is another flow chart diagram showing non-limiting steps of producing functionalized granules from fine particles.

FIG. 4 is a schematic illustration of a non-limiting agglomeration process.

FIG. 5 is a schematic illustration of an example paddle dryer for producing functionalized granules from fine particles.

FIG. 6 is a schematic illustration of an example ribbon dryer for producing functionalized granules from fine particles.

FIG. 7A is a schematic illustration of an example integrated system for silica functionalization, carbon dioxide extraction, and fines regeneration.

FIG. 7B is a schematic illustration of an example implementation of a carbon dioxide direct air capture system.

FIG. 8 is a schematic illustration of an example implementation of a carbon dioxide extraction system.

FIG. 9 is a schematic illustration of an example implementation of an integrated power and carbon dioxide extraction system.

FIG. 10A is a schematic illustration of an exploded view and an assembled view of a sample holder for testing sample CO₂ adsorption.

FIG. 10B is a schematic diagram of an experimental setup for testing sample absorption of CO₂.

In the figures, like references indicate like elements.

### DETAILED DESCRIPTION

Amorphous silica can be used as a porous structure for functionalization to achieve carbon capture. Silica substrates with amine functionalization, e.g., one or more amine-containing groups covalently bonded on surfaces, can be used to achieve reversible capture of carbon dioxide from gaseous mixtures (e.g., the atmosphere).

Through the movement of sorbents in carbon capture process equipment, particle attrition can occur, leading to the generation of “fines.” Fines typically end up in dust collection equipment rather than being recirculated through the carbon capture process.

In some embodiments, fines are distinguished by their size, as compared to particles that can be used as a sorbent. In some embodiments, fines have an average dimension or a mean dimension that is smaller than that of the particles employed within the sorbent for use in gas capture processes. In some embodiments, fines can be characterized by an average dimension or a mean dimension (e.g., diameter) that is less than 500 microns (e.g., of about 25 microns to about 500 microns). Furthermore, the distribution of a dimension (e.g., diameter, radius, length, etc.) for a plurality of fines (or a population of fines) can vary between systems, between batches of collected particles even within the same system, and/or between differing processing conditions. Accordingly, in some non-limiting embodiments, a population of fines having any distribution of dimensions and/or any average or mean dimension can be used to generate a functionalized granule (e.g., any described herein).

As used herein, the term “moiety” is used to describe characteristic parts of organic molecules. For example, an amine moiety is a molecule, compound, or portion of a compound containing an amine group (e.g., —NR^{N1}R^{N2}, as described herein), whereas a silane moiety is a molecule, compound, or portion of a compound containing a silane group (e.g., —SiR^{S1}R^{S2}R^{S3}, as described herein). In one non-limiting instance, an amine moiety can include an aminoalkyl group (e.g., -Ak-NR^{N1}R^{N2}, as described herein), as may be present in an aminosilane compound or a polymeric amine compound. The term moiety is used to describe both larger molecules containing the group, or may be used to describe the group itself.

As used herein, “interact” is used to describe covalent or non-covalent interactions between chemicals, such as by way of physical adsorption, ionic interactions, hydrogen bonding, halogen bonding, electrostatic interactions, IT bond interactions, hydrophobic interactions, inclusion complexes, clathration, van der Waals interactions, and combinations thereof.

By “acyl” or “alkanoyl,” as used interchangeably herein, is meant an aliphatic or alkyl group, as defined herein, attached to the parent molecular group through a carbonyl group. In particular embodiments, the alkanoyl is —C(O)-Ak, in which Ak is an aliphatic or alkyl group, as defined herein. In some embodiments, an unsubstituted alkanoyl is a C₂₋₇ alkanoyl group. Exemplary alkanoyl groups include acetyl.

By “acyloxy” or “alkanoyloxy,” as used interchangeably herein, is meant an acyl or alkanoyl group, as defined herein, attached to the parent molecular group through an oxy group. In particular embodiments, the alkanoyloxy is —O—C(O)-Ak, in which Ak is an aliphatic or alkyl group, as defined herein. In some embodiments, an unsubstituted alkanoyloxy is a C₂₋₇ alkanoyloxy group. Exemplary alkanoyloxy groups include acetoxy.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl, e.g., as described herein), alkenes (or alkenyl), alkynes (or alkynyl), including cyclic versions thereof, and further including straight- and branched-chain arrangements, and all stereo and position isomers as well. Such a hydrocarbon can be unsubstituted or substituted with one or more groups, such as groups described herein for an alkyl group.

By “alkyl” and the prefix “alk” is meant a branched or unbranched saturated hydrocarbon group of 1 to 24 carbon atoms, such as methyl (Me), ethyl (Et), n-propyl (n-Pr), isopropyl (i-Pr), cyclopropyl, n-butyl (n-Bu), isobutyl (i-Bu), s-butyl (s-Bu), t-butyl (t-Bu), cyclobutyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one or more alkenyl, alkoxy, alkynyl, amino, aryl, carboxyaldehyde (e.g., —C(O)H), carboxyl (e.g., —CO₂H), cyano (e.g., —CN), halo, nitro (e.g., —NO₂), oxo (e.g., ═O), and the like. The alkyl group can be a primary, secondary, or tertiary alkyl group substituted with one or more substituents (e.g., one or more halo or alkoxy). In some embodiments, the unsubstituted alkyl group is a C₁₋₃, C₁₋₄, C₁₋₆, C₁₋₈, C₁₋₁₀, C₁₋₁₂, C₁₋₁₆, C₁₋₁₈, C₁₋₂₀, C₁₋₂₄, C₂₋₆, C₂₋₈, C₂₋₁₀, C₂₋₁₂, C₂₋₁₆, C₂₋₁₈, C₂₋₂₀, C₂₋₂₄, C₃₋₈, C₃₋₁₀, C₃₋₁₂, C₃₋₁₆, C₃₋₁₈, C₃₋₂₀, or C₃₋₂₄ alkyl group.

By “alkylene” is meant a multivalent (e.g., bivalent) form of an aliphatic or alkyl group, as described herein. Exemplary alkylene groups include methylene, ethylene, propylene, butylene, etc. In some embodiments, the alkylene group is a C₁₋₃, C₁₋₄, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be substituted or unsubstituted. For example, the alkylene group can be substituted with one or more substitution groups, as described herein for alkyl.

By “alkoxy” is meant —OR, where R is an optionally substituted aliphatic or alkyl group, as described herein. Exemplary alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Exemplary unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

By “amine” or “amino” is meant —NR^{N1}R^{N2}, —NR^{N1}—, or a compound having such a group, where each of R^{N1} and R^{N2} is, independently, H, optionally substituted aliphatic, alkyl, heteroaliphatic, heteroalkyl, aromatic, or aryl; or where R^{N1} and R^{N2}, taken together with the nitrogen atom to which each are attached, form a heterocyclyl group.

By “aminoalkyl” is meant an aliphatic or alkyl group, as described herein, substituted with one, two, three, or more amine groups. The aminoalkyl can include internal amine groups or terminal amine groups. The aminoalkyl group can be further substituted. For example, the aminoalkyl group can be substituted with one or more substitution groups, as described herein for alkyl. Exemplary unsubstituted aminoalkyl groups include C₁₋₃, C₁₋₆, C₁₋₁₂, C₁₋₁₆, C₁₋₁₈, C₁₋₂₀, or C₁₋₂₄ aminoalkyl groups.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized IT-electron system. Typically, the number of out of plane π-electrons corresponds to the Huckel rule (4n+2). The point of attachment to the parent structure typically is through an aromatic portion of the condensed ring system.

By “aryl” is meant an aromatic carbocyclic group comprising at least five carbon atoms to 15 carbon atoms (C₅₋₁₅), such as five to ten carbon atoms (C₅₋₁₀), having a single ring or multiple condensed rings, which condensed rings can or may not be aromatic provided that the point of attachment to a remaining position of the compounds disclosed herein is through an atom of the aromatic carbocyclic group. Aryl groups may be substituted with one or more groups other than hydrogen, such as alkyl, as well as any substitution groups described herein for alkyl. Exemplary aryl groups include, but are not limited to, benzyl, naphthalene, phenyl, biphenyl, phenoxybenzene, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylene” is meant a multivalent (e.g., bivalent) form of an aromatic or aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for alkyl or aryl.

By “aryloxy” is meant —OR, where R is an optionally substituted aromatic or aryl group, as described herein. In some embodiments, an unsubstituted aryloxy group is a C₄₋₁₈ or C₆₋₁₈ aryloxy group.

By “carbonyl” is meant a —C(O)— group.

By “halo” is meant F, Cl, Br, or I.

By “heteroaliphatic” is meant an aliphatic group, as defined herein, including at least one heteroatom to 20 heteroatoms, such as one to 15 heteroatoms, or one to 5 heteroatoms, which can be selected from, but not limited to boron, halo, nitrogen, oxygen, phosphorus, selenium, silicon, sulfur, and, if applicable, oxidized forms thereof within the group.

By “heteroalkyl” is meant an aliphatic or alkyl group, as defined herein, containing one, two, three, or four non-carbon heteroatoms (e.g., independently selected from the group consisting of boron, halo, nitrogen (e.g., as present in imino), oxygen, phosphorus, selenium, silicon, sulfur, and, if applicable, oxidized forms thereof).

By “heteroalkylene” is meant a multivalent (e.g., bivalent) form of a heteroaliphatic or heteroalkyl group, as described herein. The heteroalkylene group can be substituted or unsubstituted. For example, the heteroalkylene group can be substituted with one or more substitution groups, as described herein for alkyl.

By “heteroaromatic” is meant an aromatic group, as defined herein, including at least one heteroatom to 20 heteroatoms, such as one to 15 heteroatoms, or one to 5 heteroatoms, which can be selected from, but not limited to boron, nitrogen, oxygen, phosphorus, selenium, silicon, sulfur, and oxidized forms thereof within the group.

By “heteroaryl” is meant an aryl group including at least one heteroatom to six heteroatoms, such as one to four heteroatoms, which can be selected from, but not limited to, boron, nitrogen, oxygen, phosphorus, selenium, silicon, sulfur, and oxidized forms thereof within the ring. Such heteroaryl groups can have a single ring or multiple condensed rings, where the condensed rings may or may not be aromatic or may contain a heteroatom, provided that the point of attachment is through an atom of the aromatic heteroaryl group. Heteroaryl groups may be substituted with one or more groups other than hydrogen, such as alkyl, as well as any substitution groups described herein for alkyl. An exemplary heteroaryl includes a subset of heterocyclyl groups, as defined herein, which are aromatic, i.e., they contain 4n+2 pi electrons within the mono- or multicyclic ring system.

By “heteroarylene” is meant a multivalent (e.g., bivalent) form of a heteroaromatic or heteroaryl group, as described herein. Exemplary heteroarylene groups include pyridinylene and the like. In some embodiments, the heteroarylene group is a C₄₋₁₈, C₄₋₁₄, C₄₋₁₂, C₄₋₁₀, C₆₋₁₈, C₆₋₁₄, C₆₋₁₂, or C₆₋₁₀ heteroarylene group. The heteroarylene group can be branched or unbranched. The heteroarylene group can also be substituted or unsubstituted. For example, the heteroarylene group can be substituted with one or more substitution groups, as described herein for alkyl or aryl.

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorus, selenium, silicon, or sulfur). The 3-membered ring has zero to one double bonds, the 4- and 5-membered ring has zero to two double bonds, and the 6- and 7-membered rings have zero to three double bonds. The term “heterocyclyl” also includes bicyclic, tricyclic, tetracyclic, or other multicyclic groups.

By “hydroxyl” is meant —OH.

By “imino” is meant —NR—, in which R can be H, optionally substituted aliphatic, alkyl, heteroaliphatic, heteroalkyl, aromatic, or aryl.

By “oxy” is meant —O—.

By “silane” is meant —SiR^{S1}R^{S2}R^{S3} or a compound having such a group, where each of R³¹, R^{S2}, and R^{S3} is, independently, H, optionally substituted aliphatic, alkyl, heteroaliphatic, heteroalkyl, aromatic, aryl, amine, or others described herein; or R^{S1} and R^{S2}, taken together with the silicon atom to which each are attached, form a heterocyclyl group.

By “thio” is meant —S—.

Disclosed herein is an agglomerated functionalized porous silica for reversibly capturing (e.g., adsorbing) carbon dioxide (CO₂), a method of producing agglomerated silica from recovered fines, and methods of recycling depleted functionalized porous silica (e.g., sorbent, or adsorbent). In general, functionalized silica is a layer of beads or powder over which gaseous mixtures including CO₂ are flowed. Gas exiting the layer of functionalized silica has a lower concentration of CO₂ than the entering gas. During carbon capture adsorption and desorption processes, the functionalized silica experiences mechanical attrition through handling and transport through the capture and regeneration processes. The attrition produces fines which can be re-functionalized and agglomerated to produce functionalized granules suitable for reintroduction into the carbon capture process equipment.

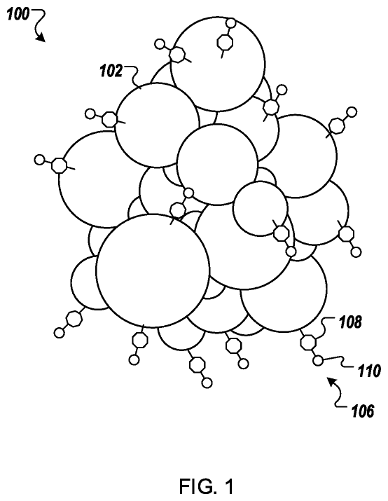

FIG. 1 is an exemplary unit of a functionalized granule 100. The functionalized granule 100 can reversibly adsorb CO₂ over a number of cycles, e.g., a number of adsorption and desorption steps. Higher cycle counts achieve longer product lifetimes when used in CO₂ capture application. In some implementations, the functionalized granule 100 reversibly adsorbs CO₂ over 100 cycles (e.g., over 500 cycles, over 1000 cycles, over 2000 cycles, over 3000 cycles). Here and throughout the specification, reference to a measurable value such as an amount, a temporal duration, and the like, the recitation of the value encompasses the precise value, approximately the value, and within ±10% of the value. For example, here 100 cycles includes precisely 100 cycles, approximately 100 cycles, and within ±10% of 100 cycles.

CO₂ adsorbed to the functionalized granule 100 is released (e.g., desorbed) under some conditions. As one example, reducing the gas pressure surrounding the functionalized granule 100 desorbs captured CO₂. This facilitates recapture of the adsorbed CO₂ in a secondary environment. In some implementations, the functionalized granule 100 is exposed to a reduced gas pressure of less than 5 psi (e.g., less than 3 psi, less than 1.5 psi, less than 1 psi, or less than 0.1 psi).

As a second example, increasing the temperature of the functionalized granule 100 destabilizes the bond between the amine moiety and the CO₂, thereby desorbing the CO₂ from the functionalized granule 100. In some implementations, the functionalized granule 100 desorbs CO₂ at temperatures above 40° C. (e.g., above 50° C., above 60° C., above 70° C., above 80° C., or above 90° C.). Increasing the temperature and decreasing gas pressure concurrently can increase the rate at which the CO₂ desorbs from the functionalized granule 100.

The fine particles 102 are in general a portion or a population of porous silica (e.g., silicon dioxide) beads or silica powder (e.g., from micrometer size to less than 0.5 millimeter size) generated during the attrition of silica sorbents (e.g., in a carbon capture process). In some embodiments, the fine particles 102 can be composed of amorphous silica, e.g., non-crystalline silica. The depicted fine particles 102 are substantially spherical, though the overall structure of the fine particles 102 can be any shape suitable for production. Furthermore, within such particles, pores can have any useful shape, configuration, distribution, and arrangement (e.g., hexagonal arrangement of pores in MCM-41, which in turn can be spherical or any other shape). Said another way, the fine particles 102 can be bead-shaped, though this is not limiting.

The diameter, or greatest dimension, of the fine particles 102 can vary based on the application and/or the source. In general, the fine particles 102 will have a distribution of diameters having an average (e.g., mean) diameter which can be of 25 micrometers (μm) to 0.5 millimeter (mm) (e.g., 45 μm to 500 μm, 50 μm to 500 μm, 60 μm to 300 μm, 45 μm to 150 μm, 70 μm to 80 μm, 50 μm to 0.5 mm, or 200 μm to 0.5 mm). In some implementations, the average diameter of the fine particles 102 are less than 500 μm (e.g., less than 400 μm, less than 350 μm, less than 300 μm, less than 200 μm, or less than 100 μm).

The width of the distribution around the average diameter affects adsorption performance of the fine particles 102. In some implementations, the width of the distribution is of 5 μm to 50 μm around the average (e.g., from 10 μm to 40 μm, or 20 μm to 30 μm). In some examples, the width of the distribution is 50 μm to 0.2 mm around the average (e.g., from 75 μm to 0.2 mm, from 100 μm to 0.1 mm, from 80 μm to 0.15 mm)

The width of the distribution can alternatively be described using D90, D50, or D10 values. Such values can be determined in any useful manner, such as by sieving. These values signify a percentage of the total distribution of the material diameters in the sample is contained, up to and including the value. For example, a D90 of 500 μm indicates 90% of the sample has a size of 500 μm or smaller. In some implementations, the functionalized granule 100 has a D10 value of 30 μm or a D90 value of 150 μm. In some examples, the functionalized granule 100 has a D10 value of 100 μm or a D90 value of 500 μm, a D10 value of 150 μm or a D90 value of 400 μm, or a D10 value of 200 μm or a D90 value of 300 μm. In some implementations, the functionalized granule has a D50 value of 1000 μm, 1100 μm, 1200 μm, 1300 μm, 1400 μm, or 1500 μm.

In general and without wishing to be bound by theory, smaller fine particles 102 size can facilitate better functionalization before agglomeration and/or enable higher CO₂ capture capacity. In some embodiments, smaller fine particles 102 can result in higher inter-particle volumes, which could enable higher gas flow capacity and faster adsorption as gas diffusion paths are shorter in the functionalized granule 100 as a whole. In other embodiments, smaller fine particles 102 size can enable relatively higher total functionalized granule 100 surface area, thereby leading to higher amine coating concentrations. In some embodiments, the use of smaller fine particles 102 with a liquid binder may provide a core for a granule having increased strength (e.g., crush strength), as compared to a particle having a porous silica core that lacks the liquid binder. In other embodiments, smaller fine particles 102 size, e.g., average radius or width, can reduce the adsorption process energy cost for a fluidization process.

The fine particles 102 includes pores, which are openings which extend from the exterior surface of the fine particles 102 into the interior volume. The pores increase the surface area of the fine particles 102. The dimensions of the pores vary from pore to pore and can vary within an individual pore. In general, the diameter of the pores is 60 angstroms (Å) to 700 Å (e.g., 60 Å to 300 Å, 60 Å to 400 Å, 60 Å to 600 Å, 80 Å to 300 Å, 100 Å to 200 Å, 150 Å to 250 Å, 60 Å to 300 Å, 100 Å to 700 Å, 200 Å to 700 Å, 300 Å to 700 Å, 500 Å to 700 Å, 100 Å to 500 Å, or 300 Å to 500 Å). In some implementations, the pores have an average dimension or a mean dimension (e.g., diameter) of about 60 angstroms to about 600 angstroms. In some implementations, the diameter of the pores is greater than 90 Å (e.g., greater than 100 Å, greater than 120 Å, greater than 150 Å). Larger diameter of the pores can increase adsorption and desorption rates and can facilitate higher filling of the pores with amine moieties without pore-clogging, which can reduce adsorption and desorption efficiency.

The pores extend into the central volume of the fine particles 102 and form interconnected channels. The pores create a volume within the fine particles 102 in which gases may flow and create additional surface area for functionalization. The volume of the pores is greater than 0.5 mL/g, and preferentially greater than 0.8 mL/g (e.g., greater than 1 mL/g, greater than 1.2 mL/g, greater than 1.5 mL/g, or greater than 1.8 mL/g). Increased total volume of the pores increases the adsorption potential of the functionalized granule 100. The pores can have an irregularly round cross-sectional shape, or a hexagonal cross-sectional shape, though this is not limiting. The total surface area of the fine particles 102 includes the outer surface and the surface area within the pores. In some implementations, the total surface area is greater than 100 m² per dry gram (m²/g) of fine particles 102. In some implementations, the total surface area is greater than 300 m²/g (e.g., greater than 200 m²/g, greater than 400 m²/g, greater than 500 m²/g, or greater than 800 m²/g). Higher total surface area increases the available area for functionalization, and increases the adsorption potential of the functionalized granule 100.

The surfaces of the functionalized granule 100 and/or the fine particles 102 are functionalized by a CO₂ adsorbing compound 106 including an aminosilane 108 and a polymeric amine 110. In some examples, the functionalized granule 100 is functionalized as a granule 100; and in other examples, the fine particles 102 are functionalized (e.g., to form functionalized fine particles) before being agglomerated into the granule 100. In further examples, the fine particles 102 are functionalized during the agglomeration process such that sub-populations of fine particles 102 are functionalized on the exposed surfaces and then assemble into the functionalized granule 100.

In some embodiments, the functionalized granule 100 has an average radius of 0.5 mm to 2.0 mm (e.g., 0.5 mm to 1.5 mm, 0.5 mm to 1.0 mm, 1.0 mm to 2.0 mm, or 1.5 to 2.0 mm). In some embodiments, the functionalized granule 100 has an average diameter of 0.5 mm to 2.0 mm (e.g., 0.5 mm to 1.5 mm, 0.5 mm to 1.0 mm, 1.0 mm to 2.0 mm, or 1.5 to 2.0 mm).

In general, fine particles can be characterized as having a higher surface area to volume ratio, as compared to larger particles. For example and without limitation, larger particles may be more spherical in shape and may have increased overall surface area provided by pores, which in turn can provide additional surface area to be functionalized. Furthermore, a population of larger particles with a narrow size distribution (e.g., a population having a diameter or average diameter of about 0.5 to about 2 mm) can provide lower overall bulk density. In turn, lower bulk density may provide a lower pressure drop across an adsorber, thereby resulting in lower energy use for capturing CO₂. In contrast, finer (e.g., smaller particles having a diameter or average diameter that is less than about 0.5 mm) having a wider particle size distribution may be characterized as having a higher bulk density, which can create a larger pressure drop across the adsorber.

In many examples, the functionalized granule 100 is characterized by mechanical properties includes crush strength, a shear strength, a density (e.g., a bulk density), a pore size (e.g., an average pore size), a porosity, and/or a pore volume (e.g., to provide desired CO₂ capture capacity). Non-limiting properties can include one or more of the following: a bulk density of about 10 lb/ft³ to about 40 lb/ft³ (e.g., about 15 lb/ft³, about 22 Ib/ft³, or about 25 lb/ft³, about 30 lb/ft³, about or 35 lb/ft³), an average pore size of about 60 angstroms to about 600 angstroms; and/or a pore volume of about 0.1 mL/g to about 2.0 mL/g (e.g., about 0.5 mL/g, or about 1.5 mL/g), a crush strength, e.g., the stress at 50% compression strain, in range of about 1 MPa to about 4 MPa (e.g., about 2 MPa to about 3 MPa), an attrition loss percentage according to ASTM D4058 testing (e.g., loss as measured from about the 30 mins duration at about 60 rpm tumble rate) of 0 wt % to about 4 wt % (e.g., about 1.5 wt %, or about 3 wt %).

Together the aminosilane 108 and the polymeric amine 110 can form a network, which in turn can provide the stable CO₂ adsorbing function. The network can include any useful combination of covalent and/or non-covalent interactions; and the network can be characterized as a coating, a matrix, or both. The aminosilane 108 includes at least one silane group (e.g., one, two, three, or more silane groups) and at least one amine group. In some embodiments, the aminosilane 108 is covalently bonded to the exterior surface of the fine particles 102 and within the pores. The aminosilane 108 can include one to three or more silane groups, e.g., silane group 208. In some implementations, the silane group includes methoxysilane, triethoxysilane, and the like), a dialkoxysilanol group (e.g., —Si(OR)₂OH, in which each R is independently alkyl), a hydrosilane group (e.g., —SiH₃), a dialkylsilane (e.g., —SiR^{S1}R^{S2}R^{S3}, in which each of R^{S1} and R^{S2} is independently alkyl, and R^{S3} is a reactive group or a leaving group, such as any described herein; and in which a non-limiting example of dialkylsilane is dialkylalkoxysilane or dialkylhalosilane), a monoalkylsilane group (e.g., —SiR^{S1}R^{S2}R^{S3}, in which R^{S1} is alkyl, and each of R^{S2} and R^{S3} is independently a leaving group or a reactive group, such as any described herein; and in which a non-limiting example of monoalkysilane is alkyldialkoxysilane or alkyldihalosilane), a trihalosilane group (e.g., —SiZ₃, in which each Z is independently halo, such as trichlorosilane), or a silanetriol group (e.g., —Si(OH)₃), as well as others described herein. Higher numbers (e.g., three or more) of silane moieties in the aminosilane 108 increase the covalent bond stability with the fine particles 102 as higher numbers of siloxane bonds between the silane moieties and the fine particles 102 surfaces increase. In the case of more than three silane groups, this refers to a molecule such as, but not limited to, bis(3-trimethoxysilylpropyl)amine. Additionally, a silane moiety can form up to 3 siloxane bonds (Si—O—Si) to the silica surface which increases stability. The number of siloxane bonds that can be formed by the silane moiety depends on the composition of the groups (X¹—X³) capable of forming siloxane bonds (e.g., —OMe, —OEt, —Cl, —OH, or a combination of any of these).

The aminosilane compound can have any useful structure. In one non-limiting example, the aminosilane includes a structure having formula (I):

[R^{A}]ₐSi[X]₄₋ₐ (I),

wherein each R^{A} is, independently, an amine moiety comprising at least one amine group; each X is, independently, a side group, a reactive group, or a leaving group; and a is an integer from 1 to 4.

The amine moiety (e.g., R^{A}) can include one or more amine groups. In one instance, the amine group can be —NR^{N1}R^{N2} or —NR^{N1}—, in which each of R^{N1} and R^{N2} is, independently, hydrogen (H), halo (e.g., F, Cl, Br, or I), hydroxyl (e.g., —OH), optionally substituted alkyl, optionally substituted aminoalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl). In some embodiments, each of R^{N1}, R^{N2}, and R is, independently, H, optionally substituted aliphatic, optionally substituted heteroaliphatic, optionally substituted aromatic, or optionally substituted heteroaromatic.

In some embodiments, the amine moiety (e.g., R^{A}) includes one, two, three, or more amine groups. In other embodiments, the amine moiety includes a terminal amine group (e.g., as —NR^{N1}R^{N2}) and an internal amine group (e.g. as —NR^{N1}—).

Non-limiting examples of amine moieties (e.g., R^{A}) include —NR^{N1}R^{N2}, -L-NR^{N1}R^{N2}, —NR^{N3}-L-NR^{N1}R^{N2}, -L²-NR^{N3}-L¹-NR^{N1}R^{N2}, -L³-NR^{S4}-L²-NR^{N3}-L¹-NR^{N1}R^{N2}, -L²—SiR^{S1}R^{S2}-L¹-NR^{N1}R^{N2}, and -L³-SiR^{S1}R^{S2}-L²-NR^{N3}-L¹-NR^{N1}R^{N2}, in which each of R^{N1}, R^{N2}, R^{S1}, and R^{S2} can be any described herein; in which each of R^{N3} and R^{N4} can be any described herein for R^{N1} and R^{N2}; and in which each L, L¹, L², or L³ is independently a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{N1}, R^{N2}, R^{N3}, R^{N4}, R^{S1}, and R^{S2} is, independently, H, optionally substituted aliphatic, or optionally substituted alkyl.

The aminosilane can include a reactive group, a leaving group, or another group (e.g., X). Non-limiting examples of such groups include H, halo (e.g., F, Cl, Br, or I), hydroxyl (e.g., —OH), optionally substituted alkyl, optionally substituted aminoalkyl, optionally substituted alkoxy (e.g., —OR, in which R is an optionally substituted alkyl), optionally substituted aryl, optionally substituted aryloxy (e.g., —OR, in which R is an optionally substituted aryl), or optionally substituted alkanoyloxy. In some embodiments, X is, independently, H, optionally substituted aliphatic, optionally substituted heteroaliphatic, optionally substituted aromatic, or optionally substituted heteroaromatic.

In one non-limiting example, the aminosilane includes a structure having formula (Ia):

R^{A1}SiX¹X²X³ (Ia),

wherein R^{A1} is an amine moiety comprising at least one amine group; and each of X¹, X², and X³ is, independently, a side group, a reactive group, or a leaving group. Each of R^{A1}, X¹, X², and X³ can be any described herein for R^{A} and X.

In another non-limiting example, the aminosilane includes a structure having formula (Ib)-(Ie):

R^{A1}-L¹-SiX¹X²X³ (Ib),

R^{N1}R^{N2}N-L¹-SiX¹X²X³ (Ic),

R^{A1}-L¹-R^{A2}-L²-SiX¹X²X³ (Id), or

R^{N1}R^{N2}N-L¹-N(R^{N3})-L²-SiX¹X²X³ (Ie),

wherein each R^{A1} or R^{A2} is, independently, an amine moiety comprising at least one amine group; each of R^{N1}, R^{N2}, and R^{N3} can be any described herein; each of X¹, X², and X³ is, independently, a side group, a reactive group, or a leaving group; and each of L¹ and L² is a linker. Each of R^{A1}, R^{A2}, X¹, X², X³, L¹, and L² can be any described herein for R^{A}, X, and L. In some embodiments, each of X¹, X², and X³ is, independently, H, halo, optionally substituted alkyl (e.g., optionally substituted C₁₋₃ alkyl), or optionally substituted alkoxy (e.g., optionally substituted C₁₋₃ alkoxy). In other embodiments, each of X¹, X², and X³ is, independently, optionally substituted alkoxy (e.g., optionally substituted C₁₋₃ alkoxy). In yet other embodiments, L is optionally substituted alkylene (e.g., optionally substituted C₁₋₁₂, C₁₋₁₀, C₁₋₈, or C₁₋₆ alkylene).

In yet another non-limiting example, the aminosilane includes a structure having formula (If):

R^{A1}R^{A2}R^{A3}SiX¹ (If),

wherein each R^{A1}, R^{A2}, or R^{A3} is, independently, an amine moiety comprising at least one amine group; and X¹ is a side group, a reactive group, or a leaving group. Each of R^{A1}, R^{A2}, R^{A3}, and X¹ can be any described herein for R^{A} and X.

In some examples, the aminosilane includes a structure of formula (II):

[R^{B}]_{b}N[Y]_{3-b} (II),

wherein each R^{B} is, independently, a silane moiety comprising at least one silane group; each Y is, independently, H, optionally substituted alkyl, or optionally substituted aryl; and b is an integer from 1 to 3. In some embodiments, each Y is, independently, H, optionally substituted aliphatic, optionally substituted heteroaliphatic, optionally substituted aromatic, or optionally substituted heteroaromatic.

The silane moiety (e.g., R^{B}) can include one or more silane groups. In one instance, the silane group can be —SiR^{S1}R^{S2}R^{S3} or —SiR^{S1}R^{S2}—, in which each of R^{S1}, R^{S2}, and R^{S3} is, independently, hydrogen (H), halo (e.g., F, Cl, Br, or I), hydroxyl (e.g., —OH), optionally substituted alkyl, optionally substituted aminoalkyl, optionally substituted alkoxy (e.g., —OR, in which R is an optionally substituted alkyl), optionally substituted aryl, optionally substituted aryloxy (e.g., —OR, in which R is an optionally substituted aryl), trialkylsilyloxy (e.g., —OSiR₃, in which each R is independently an optionally substituted alkyl), or trialkoxylsilyloxy (e.g., —OSi[OR]₃, in which each R is independently an optionally substituted alkyl). In some embodiments, each of R^{S1}, R^{S2}, R^{S3}, and R is, independently, H, optionally substituted aliphatic, optionally substituted heteroaliphatic, optionally substituted aromatic, or optionally substituted heteroaromatic.

In some embodiments, the silane moiety (e.g., R^{B}) includes one, two, three, or more silane groups. In other embodiments, the silane moiety includes a terminal silane group (e.g., as —SiR^{S1}R^{S2}R^{S3}) and an internal silane group (e.g. as —SiR^{S1}R^{S2}—).

Non-limiting examples of silane moieties (e.g., R^{B}) include-SiR^{S1}R^{S2}R^{S3}, —Si(OR^{S1})(RS2)(R^{S3}), —Si(OR^{S1})(OR^{S2})(R^{S3}), —Si(OR^{S1})(OR^{S2})(OR^{S3}), -L-SiR^{S1}R^{S2}R^{S3}, -L-Si(OR^{S1})(RS2)(R^{S3}), -L-Si(OR^{S1})(OR^{S2})(RS3), -L-Si(OR^{S1})(OR^{S2})(OR^{S3}), —SiR^{S4}R^{S5}-L-SiR^{S1}R^{S2}R^{S3}, and —SiR^{S1}R^{S2}—NR^{N1}R^{N2}, in which each of R^{S1}, RS2, RS3, R^{N1}, and R^{N2} can be any described herein; in which each of RS4 and RS5 can be any described herein for R^{S1}, RS2, and R^{S3}; and in which L is a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene. In some non-limiting embodiments, each of R^{S1}, RS2, RS3, RS4, RS5, R^{N1}, and R^{N2} is, independently, H, optionally substituted aliphatic, or optionally substituted alkyl.

In one non-limiting example, the aminosilane includes a structure having formula (IIa):

R^{B1}N^{Y1}Y² (IIa),

wherein R^{B1} is a silane moiety comprising at least one silane group; and each of Y¹ and Y² is any described herein for Y. R^{B1} can be any described herein for R^{B}.

In another non-limiting example, the aminosilane includes a structure having formula (IIb)-(IId):

R^{B1}R^{B2}N^{Y1} (IIb),

[RS1R^{S2}R^{S3}Si-L¹-]NY¹Y² (IIc), or

[RS1R^{S2}R^{S3}Si-L¹-]NY¹[-L²-SiR^{S1}R^{S2}R^{S3}] (IId),

wherein each R^{B1} or R^{B2} is, independently, a silane moiety comprising at least one silane group; each of Y¹ and Y² is, independently, a side group, a reactive group, or a leaving group; each of R^{S1}, R^{S2}, and RS3 can be any described herein; and each of L¹ and L² is a linker. Each of R^{B1}, R^{B2}, Y¹, Y², L¹, and L² can be any described herein for R^{B}, Y, and L.

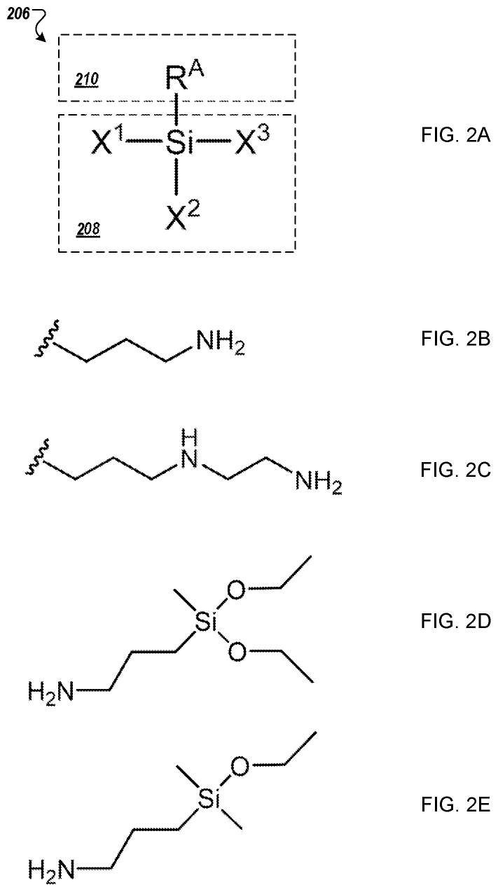

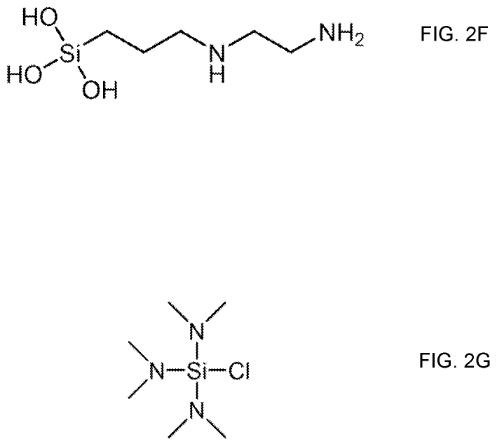

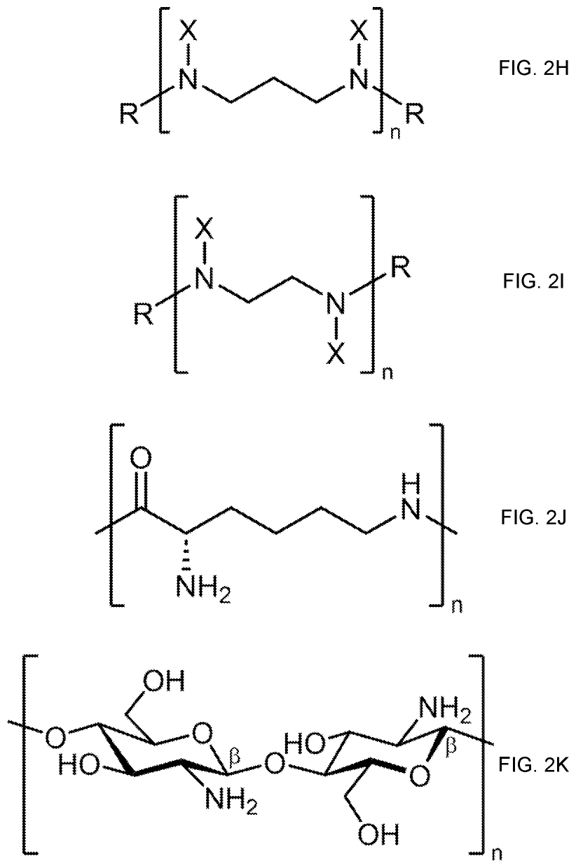

FIGS. 2A-2C depict examples of an aminosilane having a non-limiting silane group (FIG. 2A), as well as examples of amine moieties (FIGS. 2B and 2C). In FIG. 2A, an example of an aminosilane 206 having a silane group 208 is depicted having three potential interaction sites. The aminosilane 206 is an example of chemicals that can provide the aminosilane 108. The aminosilane 206 has an amine group 210, denoted R^{A}, and three silane groups 208, X¹—X³. Silane groups 208 X¹—X³ are occupied by functional groups which include, but are not limited to, a methoxy group (—OMe), an ethoxy group (—OEt), a chloro (—CI), a hydroxyl group (—OH), a hydrogen (—H), or an alkyl group (e.g., a linear alkyl group such as —(CH₂)ₙ(CH₃), in which n is an integer from 0-10; or a branched alkyl group). Yet other examples of functional groups can include any reactive or leaving group described herein. Non-limiting examples of functional groups for X can include halo, as well as optionally substituted aliphatic, alkyl, alkoxy, alkanoyloxy, heteroaliphatic, heteroalkyl, aromatic, aryl, aryloxy, and the like.

An aminosilane 206 used as aminosilane 108 can have any combination of these functional groups, e.g., amine group 210 and silane groups 208 (e.g., X¹—X³), and must have at least one amine group 210 and at least one group silane group 208 (e.g., —OMe, —OEt, —Cl, —OH, or others described herein) capable of forming a siloxane bond (e.g., an Si—O or Si—O—Si linkage). FIG. 2B is a non-limiting example of a 3-aminopropyl group which, in some examples, serves as one or more silane groups 208 or amine groups. FIG. 2C is an example of an N-(2-aminoethyl)-3-aminopropyl group which, in some examples, serves as one or more amine groups 210.

As non-limiting examples, FIGS. 2D-2G indicate examples of aminosilane 206 functionalized with silane groups 208 and an amine group 210 which would be suitable for this application, e.g., which function as aminosilane 108. FIGS. 2D and 2E are examples of an alkylalkoxyaminosilane of the type R^{A} (CH₃)_{c}Si(OEt)_{d} (e.g., in which each of c and d can be 1 or 2, such as in 3-aminopropyl (diethoxy)methylsilane and 3-(ethoxydimethylsilyl)propylamine, respectively) which, in some examples, serves as aminosilanes 108 or 206. In general and without wishing to be bound by theory, the amine groups 210 (e.g., amine moieties) of one aminosilane 206 interact with one or more of the silane groups 208 of neighboring aminosilanes 206. FIG. 2F is an example of an amino silanetriol of the type (OH)₃SiR^{A} (e.g., (3-((2-aminoethyl)amino)propyl) silanetriol) which, in some examples, serves as aminosilanes 108 or 206. FIG. 2G is an example of a chloroaminosilane of the type (R^{A})₃SiCl (e.g., tris(dimethylamino) chlorosilane, tris(ethylmethylamino)chlorosilane, and the like) which, in some examples, serves as aminosilanes 108 or 206.

The amine moieties of the aminosilane 108 can interact with one or more of the X¹—X³ sites of neighboring aminosilanes 108 or interact with polymeric amines 110. The amine moiety can be or include an amine group such as the amine groups of FIGS. 2B and 2C, which depict example aminopropyl, and N-(2-aminoethyl)-3-aminopropyl groups, respectively. In some implementations, the amine moiety is a primary, secondary, or tertiary amine group. For example, the amine moiety includes one or more aminopropyl or diethylenetriamine groups. In some implementations, the amine moiety includes more than more amine groups connected through various alkyl groups. For instance, the amine moiety can include a terminal amine group, an internal amine group, and a linker disposed between the terminal and internal amine group. Optionally, a further linker can be present between the amine moiety and the silane moiety of the aminosilane compound.

In some implementations, the aminosilanes 108 includes (3-aminopropyl)trimethoxysilane, (3-aminopropyl)triethoxysilane, [3-(2-aminoethylamino)propyl]trimethoxysilane, N-(2-aminoethyl)-3-aminopropyl silanetriol, N1-(3-trimethoxysilylpropyl) diethylenetriamine, 3-aminopropylsilanetriol, N-(2-aminoethyl)-3-aminopropylsilanetriol, tris(ethylmethylamino)chlorosilane, or tris(dimethylamino)chlorosilane or aminosilane oligomers such as VPS SIVO 280 from Evonik.

The amine moieties of the aminosilane 108 and polymeric amine compound interact with silanol groups (or other groups) of the aminosilane 108 through hydrogen bonding and ionic interactions to form a network over the silica surface. In some examples, the polymeric amine 110 is a polymeric/oligomeric amine such as polyethylenimine (PEI), poly(propylenimine) (PPI), or other large molecule amine mixture (e.g., Amix 1000, as produced by BASF, Ludwigshafen, DE). In some examples, the polymeric amine 110 is a small molecule containing amine moieties, such as tetraethylenepentamine (TEPA), triethylenetetramine (TETA), ethanolamine, diethylenetriamine, piperazine, pentaethylenehexamine, or tetramethylethylenediamine.

The polymeric amine can have any useful structure. In one non-limiting example, the polymeric amine includes a structure having formula (III):

—(R^{A}-L)ₙ- (III),

wherein each R^{A} is, independently, an amine moiety comprising at least one amine group; each L is, independently, a linker; and n is an integer greater than 1 (e.g., from 1-1000, 1-100, 1-50, 1-20, 1-10, 5-1000, 5-100, 5-50, 5-20, 5-10, as well as ranges therebetween). R^{A} and L can be any described herein. In some embodiments, R^{A} is or includes-NH—, —NR^{N1}—, —N(-L-NR^{N1}R^{N2})—, —N(-L²-NR^{N3}-L¹-NR^{N1}R^{N2})—, —N [-L²-N(-L¹-NR^{N1}R^{N2})₂]—, —NH₂, or —NR^{N1}R^{N2}, in which each of R^{N1} and R^{N2} can be any described herein; each of R^{N3} can be any described herein for R^{N1} and R^{N2}; and in which each L, L¹, or L² is independently a linker. Examples of linkers include, e.g., a covalent bond, an atom (e.g., carbonyl, oxy, thio, imino, and the like), optionally substituted alkylene, optionally substituted heteroalkylene, optionally substituted arylene, or optionally substituted heteroarylene.

FIGS. 2H and 2I depict non-limiting, general examples of polymeric amine chains which can provide polymeric amine 110. The polymeric amines of FIGS. 2H and 2I include repeating units composed of amine groups (e.g., —NH—, —NR^{N1}—, —NH₂, or —NR^{N1}R^{N2}) and linkers. In some examples, the linker can be a carbon aliphatic —(CH₂)ₙ-spacer groups, in which n is an integer greater than one (e.g., an integer from 1 to 20, 1 to 10, 1 to 12, 1 to 6, etc.). FIG. 2H shows an n-propylene (—CH₂CH₂CH₂—)(C₃H₆) spacer group. FIG. 2I shows an ethylene (—CH₂CH₂— or C₂H₄) spacer group. The polymeric amine has a repeating chain portion (bracketed) having a length of n active groups in the chain portion of the polymer (e.g., if n=2, there are two repeating groups in the chain portion). Other linkers can be used, such as any described herein (e.g., optionally substituted alkylene, as described herein), as well as linkers having peptidic bonds (e.g., —C(O)NH—) or glycosidic linkages. Linkers can include peptides, polysaccharides, and the like. Furthermore, the polymeric amine can include linear or branched structures, such as those present in linear polymers, branched polymers, block polymers, or dendrimers.

FIG. 2H depicts a polymeric amine having a length of n active groups in the repeating chain portion. FIGS. 2H and 2I depict the repeating chain portion including two amine groups (—N(X)—), separated by either three (FIG. 2H) or two (FIG. 2I) carbon spacer groups. In NX, X can be any side group, reactive group, leaving group, or other group described herein. For example, X can be H, optionally substituted aliphatic, heteroaliphatic, aromatic, and the like. Furthermore, X can include further amine groups. Thus, in some non-limiting embodiments, X can include any R^{A} group described herein. FIG. 2I depicts the amine groups extending in different orientations from the carbon chain, whereas FIG. 2H depicts the amine groups extending in similar orientations. FIG. 2J is an example of a polylysine which, in some examples, serves as polymeric amine 110. FIG. 2K is an example of a natural chitosan which, in some examples, serves as polymeric amine 110.

When exposed to a gaseous mixture including CO₂, the amine compound reacts with the CO₂ to bond the CO₂ to the functional groups. This thereby functionally adsorbs the CO₂ to the fine particles 102 through the compound 106 bonded to the fine particles 102 surface. Without wishing to be bound by theory, the total surface area, volume of the pores, and number of amine groups within the amine compound and silane compound determine the adsorption capacity of the functionalized granule 100. The adsorption capacity (e.g., uptake) of the functionalized granule 100 is about 0.5 mol to about 2.5 mol of CO₂ per dry kilogram of functionalized granule 100 (e.g., greater than 1 mol CO₂/kg, greater than 1.5 mol CO₂/kg, greater than 2 mol CO₂/kg, greater than 2.5 mol CO₂/kg, from 1 mol to 2 mol of CO₂/kg, from 1.5 mol to 2 mol of CO₂/kg, from 1 mol to 1.5 mol of CO₂/kg, from 1.5 mol to 2.5 mol of CO₂/kg, or from 2 mol to 2.5 mol of CO₂/kg). In some implementations, the functionalized granule 100 achieves CO₂ adsorption capacity up to 2 mol CO₂/kg at 420 ppm CO₂ in ambient air conditions.

In environmental conditions, the atmosphere includes a concentration of water vapor (e.g., humidity). The functionalized granule 100 captures CO₂ from atmospheric conditions in a range of relative humidity levels. For example, the functionalized granule 100 captures CO₂ from atmospheric conditions of 0% to 100% relative humidity (RH), such as for example 5% to 95% RH (e.g., 15% to 50% RH, 25% to 40% RH, or 10% to 60% RH, 5% to 90% RH, 10% to 90% RH, or 20% to 80% RH). In some implementations, the functionalized granule 100 captures CO₂ from atmospheric conditions having greater than 60% RH, greater than 75% RH, greater than 90% RH, or greater than 95% RH.

In some implementations, additives can be included in the functionalization mixtures to extend the operational lifetime of the functionalized silica. For example, the addition of Bis[3-(trimethoxysilyl)propyl]amine) to the mixture can increase the operational lifetime of the functionalized silica. BTMSPA is an aminosilane having two ends, in which each end has a trimethoxysilyl reactive group. The BTMSPA bonds on the silica substrates with six binding points, as contrasted with the three binding points for an aminosilane with a single reactive group, such as would be present in a compound having a methoxydialkylsilyl reactive group. The increased number of binding points increases binding stability with the silica substrate. The BTMSPA forms a network with other aminosilanes and polymeric amines on the surface which increases binding stability of the overall network.

In some implementations, the functionalized granule 100 includes antioxidant additives which prevent the degradation of the polymeric amines 110 by atmospheric oxygen and extends the cycling lifetime of the functionalized granule 100. For example, the antioxidant additives can be organic sulfur-containing compounds, such as 2,2-thiodiethanol, 2-hydroxyethyl disulfide, and 3,3′-dithiodipropionic acid. In general, the amount of antioxidant additives in the functionalized granule 100 is 5% wt/wt to silica (e.g., 3% wt/wt, 4% wt/wt, 6% wt/wt, or 8% wt/wt). The term wt/wt is in reference to a ratio of the weight of a first component to a second component. For example, 1 g of a first substance and 10 g of a second substance defines a 10% wt/wt ratio of the first substance to the second substance.

The antioxidant additives may be added during steps 304, 306, or 308 of the following synthesis procedure or afterward through dissolving in methanol and then soaking the silica in the additive/methanol mixture for 1 hr.

In some implementations, the functionalized granules 100 can include, or be functionalized with, other hydrophobic compounds including hydrophobic silanes or hydrophobic polymer coatings. For the hydrophobic silane, it is a silane molecule with one or two or three alkyl chains. Alkyl chains on the silane molecule can increase the hydrophobicity of the silane molecule. When the silane molecule bonds to the silica substrate, the hydrophobicity of the functionalized granule 100 increases. Thus, the water adsorption capacity of the functionalized granule 100 could be reduced, which can be beneficial for some cases such as when using the sorbent in high humidity conditions. For the same purpose of increasing the hydrophobicity of the functionalized granule 100, additional hydrophobic polymer coatings can be used.

Polydimethylsiloxane (PDMS), silicone oil, polyethylene, polytetrafluorethylene, and polyurethanes are possible hydrophobic polymers that could be used to coat the outer surface of the functionalized granule 100 to reduce water adsorption for high humidity applications.

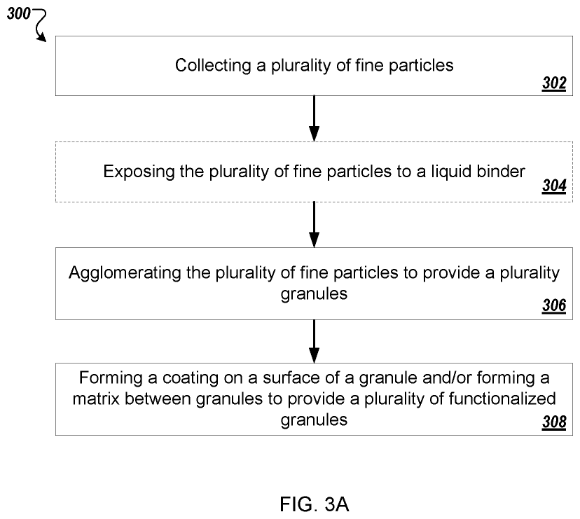

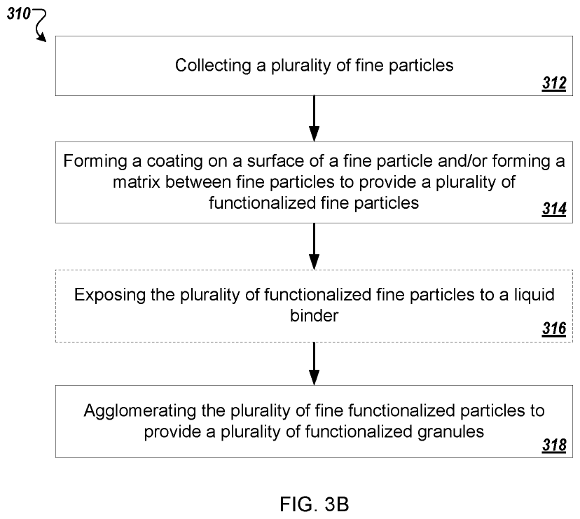

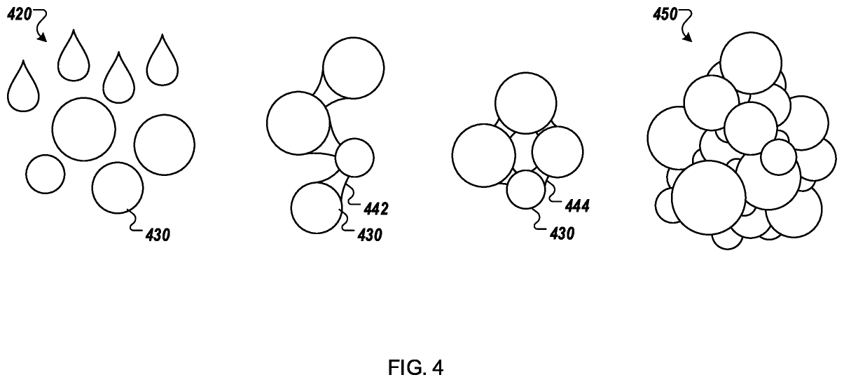

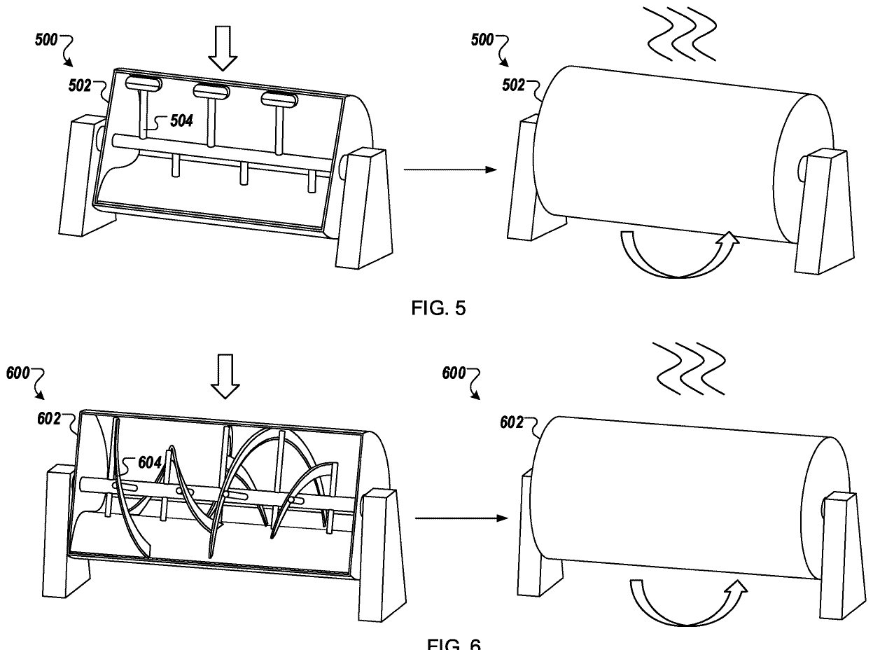

The synthesis of the functionalized granule 100 is done under industrially applicable reaction conditions, such as liquid application to fine particles undergoing tumbling or mixing motion. After agglomeration and synthesis, the adsorbent is purified, dried, and activated before using it as a CO₂ adsorbent, such as functionalized granule 100. FIG. 3A is a flow chart diagram detailing a non-limiting process 300 for making functionalized granules for use in a reversible adsorbent material, e.g., synthesizing a reversible CO₂ adsorbent, such as functionalized granule 100. FIG. 3B is a flow chart diagram detailing another non-limiting process 310 for making functionalized granules for use in a reversible adsorbent material, e.g., synthesizing a reversible CO₂ adsorbent, such as functionalized granule 100. FIG. 4 is a schematic representation of an agglomeration process.

Referring to both FIGS. 3A and 3B, in some implementations, the process 300, 310 is performed at large scale, e.g., producing 1 kilogram or more of functionalized granule 100 in a single process. In some implementations, the process 300, 310 produces 100 kilograms or more of functionalized granule 100, e.g., up to 10,000 kg). For any process conditions or characteristics described herein, batch or continuous processes may be employed. To maintain the original particle size distribution and reduce further attrition, agitation methods in which the fine particles are subjected to comparatively low friction or stirring forces are preferred, such as overhead stirring, gentle tumbling, slow and periodic stirring, or vibration.

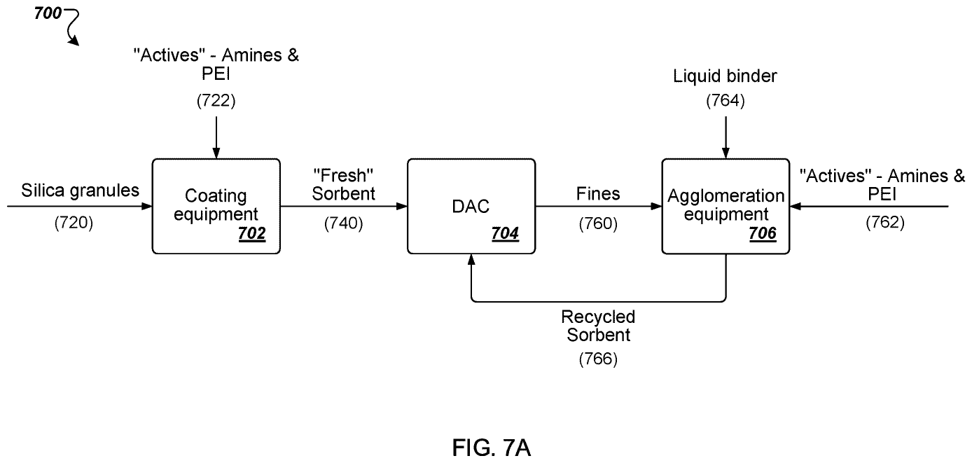

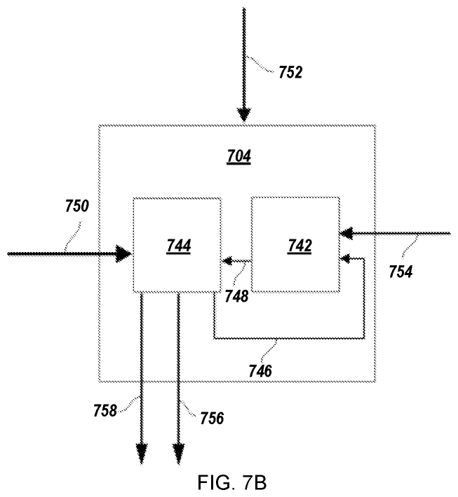

In FIG. 3A, the process 300 includes collecting a plurality of fine particles (step 302), such as fine particles 102 of FIG. 1 or fine particles 430 in FIG. 4. In general, the fine particles can be recovered in dust collecting assemblies of for CO₂ direct air capture (DAC) systems, such as the exemplary DAC system of FIG. 7B. In many examples, the fine particles are collected from dust collecting apparatuses of the DAC system and agglomerated into granules and regenerated into fresh sorbent in a vessel suitable for the total volume of the fine particles and reagents to be applied to the surfaces.

The process 300 includes optionally exposing the plurality of fine particles to a liquid binder (step 304), such as liquid binder 420 in FIG. 4. In general and without limitation, the liquid binder can include water or other solvents, and can include one or more reagents for coating and functionalizing fine particles, granules, or both. Such reagents can include a silane, an aminosilane, a silane moiety, an amine moiety, an amine moiety bound to a silane moiety, a polymeric amine, or a combination of any of these.

The liquid binder can be introduced under any useful condition. Such conditions can include providing or adjusting a tip speed, a moisture content, an addition rate of the liquid binder, a mixing time, and/or a temperature to provide sufficient agglomeration of the plurality of fine particles, the plurality of granules (if present), or the plurality of functionalized fine particles (if present).

Exposing the plurality of fine particles to a liquid binder (step 304) can result in agglomeration (e.g., formation of granules), formation of a coating, and/or formation of a matrix. Various conditions in the presence of the liquid binder can be optimized to provide desired characteristics for the granules, coating, and/or matrix.

Referring briefly to FIG. 4, the two center-most representations depict the liquid binder 420 being disposed between collected fine particles 430. In the first presentation from the left, the liquid binder can be provided by way of, e.g., a sprayer in a shear force application mixer. In the second representation from the left, the liquid binder 420 forms liquid bridges 442 between the fine particles 430. Without wishing to be bound by theory, the surface tension of the liquid binder 420 draws the fine particles 420 together into groupings of particles that can include solid bridges 444, as shown in the third representation from the left. As the shear forces and optional additional liquid binder are applied, the fine particles 430 are drawn into a large granule 450, which can provide granule 100. The application of the liquid binder 420 and/or application of shear can be ceased when the granules 450 reach a desired constraint, such as average greatest dimension, greatest dimension distribution, average density, % wetting, applied liquid binder (e.g., by weight fine particles), or other characteristic described herein.

Shear can be provided in any useful manner. Non-limiting equipment for providing shear can include a pin mixer, a paddle mixer, and/or a ribbon blender. In some embodiments, shear can be provided in the presence of a liquid binder, and non-limiting equipment can include those that can provide both shear and delivery of the liquid binder. In other embodiments, equipment can include the use of a first component configured to provide shear (e.g., a mixer or blender) and a second component configured to provide a liquid binder (e.g., a liquid handler, such as a sprayer).

In general, the size of the granules 450 depends on the residence time spent agglomerating (e.g., mixing) with higher residence times increasing the greatest dimension of the granules 450 compared to shorter residence times (e.g., mixing times). Other processing variables that can affect one or more desirable parameters of the granules 450 include tip or paddle speed of the mixer, final moisture % wt/wt of the granule 450, the application rate of the liquid binder, mixing temperature, or combinations thereof.

Referring again to FIG. 3A, the process 300 includes agglomerating the plurality of fine particles to provide a plurality of granules (step 306). In some embodiments, agglomerating (step 306) can be performed at the same time as exposing the fine particles to a liquid binder (step 304). In other embodiments, exposing the fine particles to a liquid binder (step 304) can occur initially, and agglomerating (step 306) can include introducing shear to the liquid binder and the fine particles to provide granules.

The process 300 includes forming a coating on a surface of at least one of the granules and/or forming a matrix between the granules (step 308). Forming the coating or the matrix on the granules 450 generates the plurality of functionalized granules being functional to adsorb CO₂ to the functionalized surfaces. The fine particles 430 are portions of the functionalized sorbent having functionalized surfaces with a first silane moiety and a first amine moiety, such as an aminosilane 108, and a polymeric amine 110. In some embodiments, the coating and/or the matrix can include a silane moiety (e.g., a second silane moiety) bound to the surface of at least one granule 450 and an amine moiety (e.g., a second amine moiety) bound to the silane moiety in addition to the coating previously applied to the fine particles 430 (e.g., in which the prior coating for fine particles can include a first silane moiety and a first amine moiety).

In one example, forming the coating or the matrix includes exposing the granules to a functionalization mixture introducing a first reagent including a polymeric amine and a second reagent including a silane moiety and an amine functional group (e.g., as present in an aminosilane) into a volume of solvent, e.g., water, to form a functionalization mixture.

In some examples, creating the functionalization mixture can include introducing a first reagent including a polymeric amine and a second reagent comprising a silane moiety and an amine functional group into a volume of water to form a functionalization mixture, e.g., introducing the polymeric amines 110 and the aminosilanes 108 into the volume of water. The solvent can also be organic solvent for some cases. As used herein, a reagent and a compound can be used interchangeably. Depending on use, a reagent may optionally include one or more solvents, salts, or other compounds.

The first reagent, the second reagent, and the volume of water are dispensed and mixed. The first reagent is a polymeric amine material, such as the polymeric amine compounds described herein. The water should be dispensed to fully suspend the polymeric amine material within the vessel, for example, by dispensing 20 mL/g water to polymeric amine material (e.g., 10 mL/g, 15 mL/g, or 25 mL/g). The polymeric amine material is added to the water in a range between 5% wt/wt to 20% wt/wt of the silica sorbent to be functionalized in step 308 (e.g., 6% wt/wt, 8% wt/wt, 10% wt/wt, 12% wt/wt, 14% wt/wt, 16% wt/wt, or 18% wt/wt).

The second reagent is the silane coupling material which includes the examples of aminosilanes 108 described above. The silane coupling material can be dispensed in a range between 20% wt/wt to 70% wt/wt of silica sorbent to be coated in step 308 (e.g., 25% wt/wt, 30% wt/wt, 35% wt/wt, 45% wt/wt, 50% wt/wt, or 60% wt/wt).

The liquid mixture is stirred until the polymeric amine material and the silane coupling material are fully suspended in the water. In some examples, mechanical stirring with a propeller, a magnetic stirrer, or sonication disperses the polymeric amine material in time of 5 min to 60 min (e.g., from 10 min to 30 min, from 5 min to 30 min, from 10 min to 45 min).

Optionally, agitate the functionalization mixture for a duration to allow hydrolysis of and fully dissolve the silane coupling material and polymeric amine materials. In general, the first time period is 1 minute to 10 minutes (e.g., 5 minutes).

Optionally, once the coating or matrix is formed on the granules, dry the functionalized granules. Drying the functionalized granules can include increasing the temperature, reducing the atmospheric pressure, passing an inert dry gas over the sample, passing a heated dry gas over the sample, or a combination of these. The functionalized granules are dried to remove substantially all of the liquid binder and/or functionalization mixture entrained in or on the functionalized granules.

For example, in some implementations, the functionalized granules are dried in an oven at 70° C. for between 5 minutes and 20 minutes. Drying times longer than 60 minutes reduce the absorption capacity of the final product. However, the drying time can be scale- or conditions-dependent. For example, drying under N₂ or vacuum, the drying time can be longer. In examples in which batch drying is performed, even with N₂ or vacuum, drying times may be longer than 60 mins, depending on the scale of the functionalized granules which are being dried. Alternatively, the functionalized silica material is dried in an oven at 70° C. until a hydration threshold is reached. As non-limiting examples, the hydration threshold is a weight lost by the sample of 15% (e.g., weight lost to water removal), or no further weight loss at 70° C. with inert (N₂) flow through measured on thermo-gravimetric analysis (TGA). Alternatively, the functionalized silica is dried in the oven until the water content in the material is less than 5% wt/wt.

Another non-limiting process is provided in FIG. 3B, the process 310 includes collecting a plurality of fine particles (step 312), such as fine particles 102 of FIG. 1 or fine particles 430 in FIG. 4. Certain details provided herein regarding FIG. 3A can apply equally to the process in FIG. 3B. For instance, fine particles can be recovered in dust collecting assemblies of for CO₂ direct air capture (DAC) systems, such as the exemplary DAC system of FIG. 7B.

The process 310 includes forming a coating on a surface of at least one of the fine particles and/or forming a matrix between the fine particles (step 314). Details provided herein regarding step 308 in process 300 of FIG. 3A can apply equally to step 314 in process 310 of FIG. 3B. In this process 310, the resulting particles are coated fines, which can be described as functionalized fine particles (e.g., fine particles having a functionalized surface with a first silane moiety and a first amine moiety, such as an aminosilane 108, and a polymeric amine 110).

In turn, the functionalized fine particles can be agglomerated. The process 310 includes agglomerating the plurality of functionalized fine particles to provide a plurality of functionalized granules (step 318). Details provided herein regarding step 306 in process 300 of FIG. 3A can apply equally to step 318 in process 310 of FIG. 3B. For instance, in some embodiments, agglomerating (step 318) can be performed at the same time as exposing the fine particles to a liquid binder (step 316). In other embodiments, exposing the fine particles to a liquid binder (step 316) can occur initially, and agglomerating (step 318) can include introducing shear to the liquid binder and the fine particles to provide granules.

The process 310 can include optionally exposing the plurality of fine particles to a liquid binder (step 314), such as liquid binder 420 in FIG. 4 or any liquid binder described herein. Exposing the plurality of functionalized particles to a liquid binder (step 316) can result in agglomeration (e.g., formation of granules), formation of additional coating, and/or formation of additional matrix. Various conditions in the presence of the liquid binder can be optimized to provide desired characteristics for the granules, coating, and/or matrix.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

The regenerated adsorbent can be reused through the desorption process. For example, the regenerated adsorbent can be reused 100 times or more (e.g., 1000 times or more, 10000 times or more). For the desorption process, the sample was heated to 70° C. under vacuum for 30 mins (the duration may change based on temp/vacuum level). This facilitates the CO₂ captured during the adsorption process to be released which can be collected for further sequestration, described with reference to the systems for direct air capture below. An aspect of the desorption process is to maintain the adsorbent heated under a water vapor filled vacuum environment (e.g., >10% relative humidity). This reduces regenerated adsorbent degradation.

### Agglomeration Systems

FIGS. 5-6 are example systems by which the functionalized granule 100 is produced in agglomeration and coating methods, such as process 300, 310, described herein.

FIGS. 5 and 6 show two different examples of drum mixers which can be used for mixing the functionalization mixtures, exposing the fine particles to the liquid binder, agglomerating the fine particles into granules, and/or drying of the functionalized granules. In some embodiments, drum mixers can be used for mixing the functionalization mixtures, exposing the fine particles to the functionalization mixtures to provide functionalized fine particles, agglomerating the functionalized fine particles into granules, and/or drying of the functionalized granules.

In the left image of FIG. 5, a paddle mixer 500 includes a cylindrical drum 502 in which mixing occurs. A paddle agitator 504 rotates independently of the drum 502 to mix the functionalization mixture, or the liquid binder and the fine particles. Fine particles are dispensed into the drum 502 and the paddle agitator 504 rotates to agitate the fine particles in the liquid binder/functionalization mixture. The agitator 504 applies shear forces to the fine particles to cause the agglomeration into granules.

In the left image of FIG. 6, a ribbon mixer 600 includes cylindrical drum 602 in which mixing occurs by a ribbon agitator 604 which rotates independently of the drum 602. Fine particles are dispensed into the drum 602 and the ribbon agitator 604 rotates to agitate the fine particles in the liquid binder and/or functionalization mixture.

Examples of the paddle mixer 500 and ribbon mixer 600 can include heating mechanisms, such as jacketed drums 502 and 602, or forced gas venting to flow heated gas over the functionalized silica particles after separating the particles from the liquid functionalization mixture. In some examples, the heated gas can be air, or an inert gas (e.g., nitrogen, N₂). If a heat carrier is flown through a jacket of the paddle mixer 500 or ribbon mixer 600, the heat carrier can be heated oil, steam, or hot water. If the heat carrier is flown inside the vessel (e.g., forced gas venting), an inert gas such as N₂ can be used. However, in examples of forced gas venting air should be avoided to prevent oxidation.

### Recycling Methods

In general, the adsorptive capacity of the functionalized sorbent described herein may be reduced below a useful threshold following multiple cycles of adsorption and desorption. Without wishing to be bound by theory, amines bound to the functionalized silica described herein can become degraded during cycles of adsorption and desorption. Mechanisms of degradation can include thermal (e.g., excessive heat), mechanical (e.g., physical attrition), or chemical degradation (e.g., exposure to reactive oxygen species).

Sorbent that has been degraded below a useful threshold can be termed ‘depleted’ sorbent. The useful threshold can be a threshold below which the sorbent does not efficiently bind carbon dioxide, or below which the absorptive capacity of the sorbent is no longer commercially viable. In one example, the threshold is determined by the carbon dioxide absorption capacity of a sample of the sorbent. Sorbents having an absorption capacity of 0.5 mol CO₂/kg or less can be considered depleted (e.g., 0.4 or less, or 0.3 or less).

Examples of recycling methods include regeneration methods. In general, regeneration methods include agglomeration of fines (as described further herein), and regeneration or reduction of the amines of the depleted sorbent. Agglomeration and regeneration of the amines can produce newly regenerated functionalized silica which can be reintroduced into the carbon capture processes and systems described herein.

Examples of recycling methods include passivation methods. Passivation methods can produce passivated sorbent which can be reused as, in some examples, industrial filler or unfunctionalized silica substrate for feed stock. Passivation methods can include calcination, acid/base stripping, or chemical reaction (e.g. ozone treatment) of the depleted sorbent.

In one example, calcination of the depleted sorbents includes heating the depleted sorbents to or above a temperature at which thermal decomposition of the functionalization network occurs. The functionalization network is degraded by the heating process and can then be removed from the calcined sorbent. The calcined sorbent can then be disposed of or re-functionalized in a functionalization process.

The temperature to which the depleted sorbent is raised can be below the glass transition temperature of the silica substrate to prevent thermal damage to the silica substrate, e.g., a reduction in porosity or pore volume of the silica substrate, e.g., to prevent crystallization of the silica substrate. At elevated temperatures, the amorphous silica can begin to reorder into a crystalline phase. This reordering has a rate dependence on the temperature. At higher temperatures and longer times, more of the silica will reorganize into crystalline phases. Slow cooling can allow the silica time to continue crystallizing, e.g., an annealing process. Rapid heating and cooling will burn off the amine coating and reduce the time available for the silica to crystallize.

The calcination temperature can be 300° C. to 900° C. (e.g., from 350° C. to 800° C., or from 400° C. to 700° C.). The depleted silica is heated to the calcination temperature quickly, e.g., heated to reach the calcination temperature in 90 minutes or less (e.g., 60 minutes or less, or 45 minutes or less). The calcined silica can be cooled quickly, e.g., reduce to below the calcination temperature in 90 minutes or less (e.g., 60 minutes or less, or 45 minutes or less).

In some examples, calcination is performed under a restricted supply of oxygen, e.g., in a vacuum, or under an inert gas, e.g., nitrogen. Performing calcination under inert conditions may leave a higher carbon and/or nitrogen content on the calcined substrate from the functionalization network after calcination. A higher carbon and/or nitrogen content can facilitate usage of the calcined sorbent in downstream re-use method, such as a filler, thickening agent, or resin binder.

In some examples, calcination is performed under conditions with oxygen present. Calcination in the presence of oxygen may reduce the carbon content remaining on the surface and in pores of the calcined substrate, thus reducing the effect of calcination on the porosity or pore volume of the calcined substrate. Calcined sorbent having comparatively high porosity or pore volume can be re-functionalized to produce fresh sorbent for carbon capture.

Optionally, the calcined particles are cooled at a rate sufficient to prevent crystallization of the calcined particles, e.g., to achieve a temperature of less than 100° C. in one hour or less, e.g., at a rate greater than or equal to 50° C./min.

An example of a regeneration method includes reduction of the depleted sorbent. Reducing the depleted sorbent facilitates reuse of the reduced sorbent in the regeneration systems described herein, thus providing increased sorbent lifetime and increased sorbent cycle counts. The reduction can include exposing the depleted sorbent to a gas phase or a liquid phase reducing agent. In general, the reducing agent can include, for example, hydrogen gas or a hydride (e.g., sodium borohydride). Examples of reduction products of the active alkylamines are amides, imines, and ureas. Reduction of these compounds back to amines or amides with alpha alcohols may restore the carbon capture performance of the amine coatings.

A gas phase reducing agent can produce less waste than a liquid phase reduction, while a liquid phase reduction can provide reduced exposure times than a gas phase reduction.

Example of the gas phase reduction can include exposing the depleted sorbent to hydrogen gas. In examples of liquid phase reduction, a solvent may be used which does not react with the functionalization network, e.g., a non-polar solvent, e.g., hexane, benzene, toluene, or tetrahydrofuran (THF). The reducing agent is then introduced with the solvent to reduce the functionalization network. The solvent selected for reducing can prevent the formation of salts in the depleted sorbent. Choosing a non-reactive solvent, e.g. a non-polar solvent, can prevent the coated amines being washed off the coated sorbent such that the reduced amines remain on the silica surface after reduction.

Another example of the reduction method include electrochemical reduction in which an external voltage is applied to the depleted sorbent suspended in a carrier liquid. Electrochemical reduction can be performed as an alternative, or in addition, to exposure to the gas or liquid phase reducing agent.

A further example of the passivation method includes rinsing the functionalization mixture from the depleted sorbent. The depleted sorbent can be exposed to a strong acid or base rinsing agent, e.g., singularly or sequentially, to remove the amine moieties and the silane moieties from the porous silica substrate. An example of the rinsing agent can be an aqueous solution having a pH of about 0 pH or about 14 pH. The silica substrate can then be removed from the rinsing agent. Optionally, the silica substrate can then be exposed to a second rinsing agent having a different pH, or the second rinsing agent can be water. The rinsing agent can be a polar solvent, e.g., ethyl acetate or acetone. The silica substrate can then be re-functionalized thus reducing the material cost of providing functionalized silica and reducing the waste stream of producing the silica sorbent.

One example of the passivation method includes exposing the depleted sorbent to a strong acid, e.g., hydrogen chloride (HCl), pH=0. Acid will convert the alkylamines to alkylammonium has increased solubility. The depleted sorbent is then removed from the acid. The depleted sorbent is then exposed to a strong base, e.g., sodium hydroxide (NaOH), pH=14. The base treatment can neutralize the acid and dissolve a thin layer of the silica surface to remove any other residuals such as aminosilanes. The depleted sorbent is then removed from the base. Optionally, the depleted sorbent can be rinsed with the neutral agent, e.g., water, to remove any remaining residuals, e.g., salts, to provide passivated silica. The passivated silica can then be re-functionalized using methods described herein.

In examples in which the functionalization network includes a polymer, e.g., PEI, the depleted sorbent can be exposed to a methanol, ethanol or water wash to remove the PEI relatively easily as PEI has good solubility in these solvents. Some of the aminosilanes may also be washed off with methanol, ethanol, or water. Then the acid and base wash can fully clean the silica surface to achieve passivation and regeneration.

Yet a further example of the passivation method includes exposing the depleted sorbents to an oxidizing agent which chemically oxidizes the amine moiety and the silane moiety, e.g., ozone. Amine reaction with ozone will produce various examples of oxidation products, e.g., such as amides, nitrites, nitrosos, or nitrates. Some products of ozone treatment are water, CO₂ and N₂. An advantage of ozone treatment is that the reaction can be carried out at room temperature. Treating a sorbent with a smaller amount of ozone can passivate the amines by converting them to oxidized products which can be less environmentally problematic. Treating the sorbent with excess ozone will remove the organics from the silica substrate.

Examples of recycling methods include repurposing methods. In general, repurposing methods include providing the depleted sorbent as fillers, providing the depleted sorbent as a soil additive, or providing the depleted sorbent as a silica feed stock.

The depleted sorbent includes porous silica particles having a silica oxide composition having high durability which can be beneficial in industrial processes. The depleted silica sorbent can be useful in applications which enhance resistance to friction, as mechanical binding agents, or as cost-effective fillers when mixed with other materials. The surfaces of the depleted sorbent are coated in the functionalization network. In some examples, the functionalization network can be removed prior to being provided for repurposed uses. Alternatively, the functionalization mixture can be modified to suit the purpose of the repurposed application.

One example of providing the depleted sorbent as a filler includes for use as a filler in a rubber, e.g., synthetic rubber, or other polymers. The depleted sorbent can be used as a filler in synthetic rubber tires. Synthetic rubber including a portion of silica oxide as a filler can increase the durability of the synthetic rubber (e.g., increased friction resistance, increased damage resistance). Tires made using a portion of silica oxide as a filler can have decreased rolling resistance. The depleted sorbent may be treated to include sulfur in applications for synthetic rubber tires. Another example of providing the depleted sorbent as a filler includes for use as an epoxy resin filler, or a plywood filler. Amine-containing chemicals can be compatible with common epoxide and formaldehyde-based resins. The amines groups can react with the active parts of the polymer. The silica pieces can be compatible with resins or epoxides and increase the mechanical strength of the composite.

The high purity silica oxide composition of the depleted sorbent provides a source for high purity silica oxide applications, e.g., as a silica source for a silica manufacturing process. Briefly and without expressing limitation, silica can be produced from sand and reacted with sodium hydroxide to form sodium silicate. The sodium silicate can be reacted with a strong acid to form silicic acid. The silicic acid can then be solidified to form silica. The depleted sorbent can be used for the same process to re-form the silica. As another example, the amines on the depleted sorbent can be passivated, or converted, to become a nitrogen source, e.g., a fertilizer, a nitrogen source for plants, or soil additive, to facilitate a safe “return” to the environment. In one example the amines coating the depleted sorbent can be converted to urea which can be broken down in the soil to provide a source of nitrogen, e.g., for plants. The urea conversion can be done via exposure of the sorbent amines to a conversion agent, such as CO₂ or formaldehyde in a gas phase or liquid phase batch method. In one example, the depleted sorbent is exposed to a gas including substantially pure CO₂ at an elevated temperature 100° C. to 120° C. Optionally, the depleted sorbent is dried to a moisture content of 5% wt/wt or less before being exposed to the conversion agent.

### Example Regeneration System

Examples of systems for direct air capture (DAC) of CO₂, fines collection, agglomeration, and recycling of the regenerated adsorbent of the present disclosure are described with reference to FIG. 7A. A schematic illustration of an example implementation of an integrated silica system 700 for functionalization, carbon dioxide extraction, and fines regeneration is shown in FIG. 7A.

The functionalized silica particles, e.g., “fresh” sorbent, are generated by coating equipment 702, such as examples of the mixing and exposing systems described in FIGS. 5-6. Briefly, functionalization mixture 722 including reagents such as polymeric amines and aminosilanes, such as those described herein, are mixed with silica particles 720 in the coating equipment 702 to create functionalized silica particles 740 for carbon capture and sequestration. The functionalized silica particles are utilized in a direct air capture (DAC) system 704, examples of which are described further herein with reference to FIGS. 7B, 8, and 9.

The DAC system 704 includes an inlet for receiving the fresh sorbent 740 from the coating equipment 702. The DAC system 704 uses the functionalized silica particle adsorbent in a carbon dioxide extraction process.

Referring to FIG. 7B, a non-limiting example of a DAC system 704 is provided. The carbon dioxide DAC system 704 includes an adsorber system 742 and a desorber system 744. The carbon dioxide DAC system 704 can also receive a heated fluid 750, a power input 752, and an ambient airflow input 754. The carbon dioxide DAC system 704 outputs a carbon dioxide supply stream 756 and a carbon dioxide-reduced airflow output stream 758.

The adsorber system 742 generally operates to pass the ambient airflow input 754 (which includes gaseous carbon dioxide) over or through one or more adsorbent reactors under conditions at which the adsorbent adsorbs CO₂ from the air. The adsorbent can include any functionalized particle or functionalized granule described herein. Non-limiting reactors can include one or more moving packed beds, fluidized beds, and the like. As used herein and unless otherwise specified, “adsorbent” and “sorbent” may be used interchangeably. In some non-limiting embodiments, a sorbent includes a population of functionalized granules.

The adsorbent, in some aspects, includes a solid adsorbent to which the atmospheric carbon dioxide in the airflow input 754 bonds. For example, the solid adsorbent can be in a pelletized or powdered form. As the airflow input 754 passes over the solid media, atmospheric carbon dioxide within the airflow input bonds to the adsorbent. The adsorbent that is saturated with carbon dioxide may be referred to as “rich adsorbent.” When the media is saturated with carbon dioxide, it can be heated (e.g., to 80-120° C.) to release the carbon dioxide for collection. For instance, rich adsorbent 748 can exit the adsorber system 742 and enter the desorber system 744.

The desorber system 744 uses thermal energy from a heated fluid 750 to apply heat to the solid or liquid rich adsorbent 748. The heat dissolves the bonds between the carbon dioxide and the rich adsorbent 748. The separated carbon dioxide is provided as the carbon dioxide supply stream 756 from the carbon dioxide DAC system 740. The adsorbent exiting the desorber system 744 may be referred to as “lean adsorbent,” e.g., adsorbent that is carbon dioxide free. Lean adsorbent 746 exits the desorber system 744 and is recycled back to the adsorber system 742. The lean adsorbent 746, in the filters of the adsorber system 742, captures more carbon dioxide from the ambient airflow input 754. The airflow output 758 typically, contains little to no carbon dioxide.

The rich adsorbent is moved between the adsorber system 742 and desorber system 744 causing mechanical stresses on individual particles, thereby causing attrition of the particles into fines. Collection of fine particles can occur during transport of rich adsorbent 748 and/or lean adsorbent 746 between the adsorber system 742 and the desorber system 744; and/or during transport of the carbon dioxide supply stream 756 or the airflow output 758 out of the desorber system.

The DAC system 704 encloses the adsorber system 742 and desorber system 744 to prevent the loss of the fines as dust to the environment and includes filtration systems to collect and sequester the fines. In some embodiments, the fines are collected and transferred via an outlet to agglomeration equipment 706 for agglomeration and regeneration processes, such as process 300, 310. Some examples of the fines collection include vacuum systems, sieving and filtrating systems, and cyclonic separators. In general, silica particles having a greatest dimension that is 0.5 mm or less (e.g., 0.4 mm or less, 0.3 mm or less, or 0.2 mm or less) is separated from the adsorbent during handling and transfer processing in the DAC system 704.

The fines 760 are transferred to agglomeration equipment 706, such as the examples shown in FIGS. 4-6. The agglomeration equipment 706 includes a liquid handler system (e.g., a sprayer) to expose the fine particles to a liquid binder 764, such as water, solvent, or any example described herein. The agglomeration equipment 706 includes a mixer to apply shear forces to the wetted fine particles to induce the creation of granules, such as granules 450. A functionalization mixture 762 containing aminosilanes and polymeric amines (e.g., PEI) is introduced to the agglomeration equipment. The functionalization mixture can be introduced to the fines, as the liquid binder, during application of the shear forces to the fines, or once the fines have agglomerated into the granules. The point at which the functionalization mixture is introduced to the fines can affect CO₂ uptake capacity, mechanical strength, and/or friability of the functionalized granule.

The DAC system 704 includes a second inlet for receiving the functionalized granules, e.g., the recycled sorbent 766, to the sorbent-containing systems of the DAC system 704 for re-use in the adsorber system 710 and desorber system 712. In one embodiment, the recycled sorbent 766 can be introduced into the adsorber system 742 in any useful manner. For example, the recycled sorbent 766 can be combined with the lean adsorbent 746 for delivery into the adsorber system 742. In another example, the recycled sorbent 766 can introduced into another inlet in communication with the adsorber system 742 (e.g., in communication with a fluidized bed containing an adsorbent material, which in turn can include fresh and/or recycled granules 100). In yet another example, the recycled sorbent 766 can be combined with the rich adsorbent 748 for delivery into the desorber system 744, which processes the recycled sorbent 766 with the rich adsorbent 748 for further delivery as a lean adsorbent 746 back into the adsorber system 742.

Optionally, the DAC system 704 includes one or more blowers each arranged to receive ambient air and blow air (e.g., as ambient airflow input 754) into the adsorber system 742. The fresh and/or recycled granules 100 contained in the adsorber system 742 can then adsorb atmospheric CO₂ from the ambient airflow input 754.

Optionally, the DAC system 704 includes one or more exhaust ports each configured to remove air from the adsorber system 742 and/or the desorber system 744. This air may include fine particles, which in turn can be provided to agglomeration equipment 706. In some embodiments, the outlet of the DAC system is in fluidic communication with at least one of the one or more exhaust ports.

In one example, the exhaust port is configured to remove air (e.g., with concomitant fine particles) from an inlet to the adsorber system 742, an outlet from the adsorber system 742, an inlet to the desorber system 744, or an outlet to the desorber system 744. Additionally or alternatively, a stream containing rich adsorbent 748 or lean adsorbent 746 can be in fluidic connection with the exhaust port, in which fine particles within such streams can be separated and transported to the exhaust port. Additionally or alternatively, the outlet(s) of the DAC system 704 (e.g., outlet for providing the carbon dioxide supply stream 756 or the airflow output 758) can be in fluidic connection with the exhaust port.

In some examples, the functionalized granules are sieved, e.g., filtered, before the DAC system 704 receives the granules. The granules are sieved to remove granules that are outside of the desirable range of granule greatest dimension (e.g., granules less than 0.5 mm, greater than 2 mm, or both) are separated. Separated granules below the minimum greatest dimension can be returned to the agglomeration equipment 706 for further agglomeration and/or coating.

### Example Direct Air Capture Systems

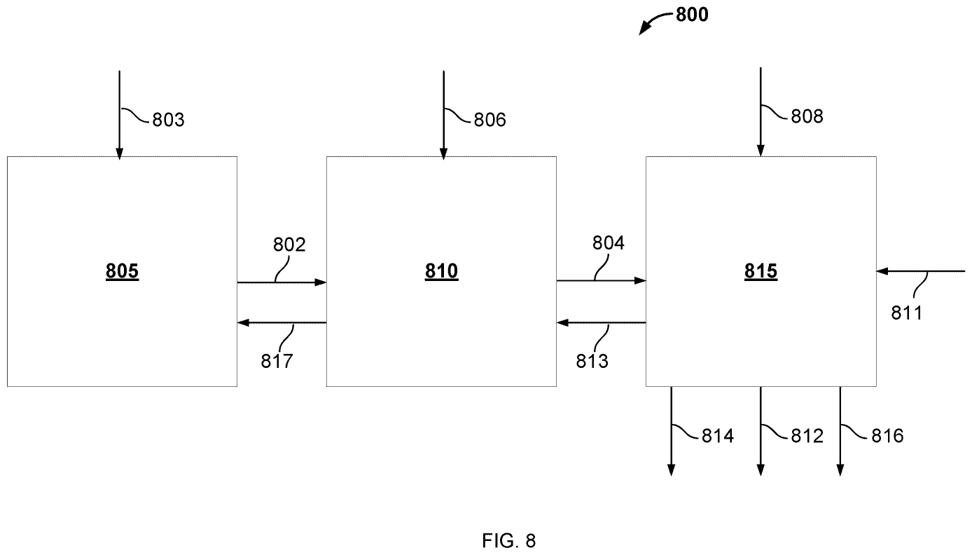

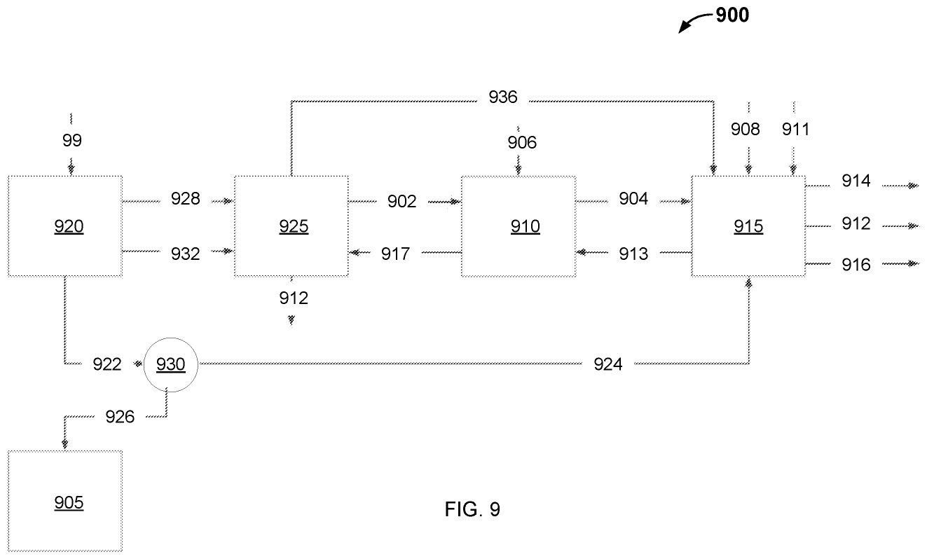

Examples of DAC systems of CO₂ using the regenerated adsorbent of the present disclosure are described with reference to FIGS. 8 and 9, examples of which are described in U.S. patent application Ser. No. 17/216,902, the disclosure of which is hereby incorporated by reference in its entirety. FIG. 8 is a schematic illustration of an example implementation of a carbon dioxide extraction system 800. As illustrated, the carbon dioxide extraction system 800 includes an industrial process 805 that generates waste heat 802. In some implementations, the industrial process utilizes a power input 803. The waste heat 802 is supplied, in this example, to a thermal heat-reuse system 810 that also utilizes a power input 806. The thermal heat-reuse system 810 provides a heated fluid 804 to a carbon dioxide DAC system 815. The carbon dioxide DAC system 815 also receives a power input 808 and an ambient airflow input 811. The carbon dioxide DAC system 815 outputs a carbon dioxide supply stream 812, a carbon dioxide-reduced airflow output stream 814, and demineralized water 816.

Generally, the carbon dioxide extraction system 800 operates to utilize the heated fluid 804 as thermal energy that is generated from the waste heat 802 by the thermal heat-reuse system 810. The thermal energy in the heated fluid 804 is used by the carbon dioxide DAC system to separate carbon dioxide captured from the ambient airflow input 811 and supply the separated carbon dioxide as the carbon dioxide supply stream 812. The heated fluid 804 is then returned via heated fluid return 813 to the thermal heat-reuse system 810, and the waste heat 802 is returned to the industrial process 805 via waste heat return 817. In some aspects, the carbon dioxide supply stream 812 can be provided as an injectant into a subterranean formation during hydrocarbon production operations. In some aspects, the injected carbon dioxide may be sequestered in the subterranean formation (with or without assisting in the hydrocarbon production operations).

The industrial process 805 may be any process that generates, as an output, thermal energy in the form of waste heat, e.g., energy, that, unless captured, that otherwise would be lost to, e.g., the ambient environment. As an example, the industrial process 805 may be a computer data center that, generally, houses computer systems and associated components, such as telecommunications and storage systems. In some aspects, a data center includes tens, hundreds, thousands, or even more server devices that generate heat, such as hardware processors, voltage regulators, memory modules, switches, and other devices that operate to provide a particular amount of information technology (IT) power.

Such devices, typically, utilize electrical power to operate and output heat during operation. In order for such devices to operate correctly, the output heat must be captured in a cooling fluid flow (e.g., air, water, refrigerant) and expelled from the data center. For instance, air handling systems (e.g., fans, cooling coils) may operate to capture the output heat in an airflow circulated over the heat-generating components. The output heat now within the airflow is transferred to a cooling liquid, e.g., within a cooling coil. The heat transferred to the cooling liquid is then typically rejected to the ambient environment as waste heat, such as through evaporative cooling systems, chiller/cooling tower systems, or otherwise. In this example, this waste heat takes the form of waste heat 802.

The example thermal heat-reuse system 810 utilizes the waste heat 802 and power input 808 to provide the heated fluid 804. The thermal heat reuse system 810 consists of a bank of heat pumps and a bank of heat exchangers to provide the heated fluid 804. By balancing the use of passive and active heating, power can be saved to provide the carbon dioxide DAC system with the required temperatures of heated fluid 804. Generally, the thermal heat-reuse system 810 includes one or more vapor-compression cycles (“heat pumps”) to add thermal energy in the form of heat of compression to the waste heat 802 and transfer the sum of such energy to a fluid to generate the heated fluid 804 (e.g., a heated liquid). Generally, each heat pump and heat exchanger within the thermal heat-reuse system 810 operates to transfer thermal energy from a heat sink to a heat source, i.e., in an opposite direction of spontaneous heat transfer. The one or more heat pumps of the thermal heat-reuse system 810 use the power input 806 to accomplish the work of transferring energy from the heat source to the heat sink. Each heat pump in the thermal heat-reuse system 810 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components are fluidly coupled within a closed-loop refrigerant circuit in the heat pump.

As is generally known, in a vapor-compression heat pump cycle, a refrigerant exits a first heat exchanger in which heat from the refrigerant is released to a first medium. The refrigerant then enters a compressor in which it is compressed and a heat of compression is added thereto. The refrigerant then enters a second heat exchanger in which heat from a second medium is added. The refrigerant then enters an expansion device and undergoes an isenthalpic pressure drop. The refrigerant completes the cycle by entering the evaporator to release the heat of compression and the heat from the second medium to the first medium.

Although the present disclosure describes a vapor-compression heat pump cycle as a heat transfer system between a source of waste heat and a carbon dioxide DAC system, other thermodynamic cycles may also be used in place of (or along with) the described vapor-compression heat pump cycle. For example, one or more vapor-adsorption cycles may be used in place of (or along with) the described vapor-compression heat pump cycle. A vapor-adsorption cycle, for example, consists of a cycle of desorption-condensation-expansion-evaporation, followed by adsorption.

The carbon dioxide DAC system 815, generally, operates to pass the ambient airflow input 811 (which includes gaseous carbon dioxide) over or through one or more media (e.g., “filters”). In some aspects, one or more fans (not shown) utilize the power input 808 to circulate the ambient airflow input 811. The media or filter, in some aspects, includes a solid adsorbent to which the atmospheric carbon dioxide in the airflow input 811 bonds. The adsorbent that is saturated with carbon dioxide may be referred to as “rich adsorbent.”

In the case of a solid sorbent, such as the sorbent described in the present disclosure, as the airflow input 811 passes over the solid media or filter, atmospheric carbon dioxide within the airflow input 811 bonds to the media or filter. When the media or filter is saturated with carbon dioxide, it can be heated (e.g., to 600-620° C., to 60-100° C.) to release the carbon dioxide for collection (as described below).

Using thermal energy from the heated fluid 804, heat is applied to the solid or liquid adsorbent, which breaks the bonds between the carbon dioxide and the sorbent. The separated carbon dioxide is provided as the carbon dioxide supply stream 812 from the carbon dioxide DAC system 815. The now-“lean adsorbent” that is carbon dioxide free (i.e., the solid or liquid) is recycled back to capture more carbon dioxide from the ambient airflow input 811. The airflow output 814, typically, contains little to no carbon dioxide.

FIG. 9 is a schematic illustration of an example implementation of an integrated power and carbon dioxide DAC system (“integrated system”) 900. As illustrated, the integrated system 900 includes a natural gas plant 920 attached to a CCS flue gas carbon dioxide scrubber 925 that generates waste heat 902. The waste heat 902 is supplied, in this example, to a thermal heat-reuse system 910 that also utilizes a power input 906. The thermal heat-reuse system 910 provides a heated fluid 904 to a carbon dioxide direct air capture (DAC) system 915.

A natural gas plant 920 generates flue gas 932 containing carbon dioxide and electrical power 928 that is sent to the CCS flue gas carbon dioxide scrubber system 925. The scrubber system 925 separates out the carbon dioxide 912 from the flue gas 932. The scrubber system 925 provides waste heat 902 to a carbon dioxide direct air capture (DAC) system 915. The carbon dioxide DAC system 915 also receives a power input 908 and an ambient airflow input 911. The carbon dioxide DAC system 915 outputs a carbon dioxide supply stream 912 and a carbon dioxide-reduced airflow output stream 914.

Generally, the integrated system 900 operates to capture the waste heat 902, generate the heated fluid 904 that has a thermal energy that includes the waste heat 902, as well as heat of compression from the thermal heat-reuse system 910, and utilize such thermal energy in the heated fluid 904 to separate carbon dioxide captured from the ambient airflow input 911 to supply the separated carbon dioxide as the carbon dioxide supply stream 912. In some aspects, the carbon dioxide supply stream 912 can be provided as an injectant into a subterranean formation during hydrocarbon production operations. In some aspects, the injected carbon dioxide may be sequestered in the subterranean formation (with or without assisting in the hydrocarbon production operations).

In this implementation, the industrial process 905 is powered by the natural gas plant 920 rather than the electrical power grid since the electrical power 926 would be considered carbon negative electricity.

The example thermal heat-reuse system 910 utilizes the waste heat 902 from the CCS Flue Gas CO₂ Scrubber 925 and power input 906 to provide the heated fluid 904. Generally, the thermal heat-reuse system 910 includes one or more vapor-compression cycles (“heat pumps”) to add thermal energy in the form of heat of compression to the waste heat 902 and transfer the sum of such energy to a fluid to generate the heated fluid 904 (e.g., a heated liquid). Generally, each heat pump within the thermal heat-reuse system 910 operates to transfer thermal energy from a heat sink to a heat source, i.e., in an opposite direction of spontaneous heat transfer. The one or more heat pumps of the thermal heat-reuse system 910 use the power input 906 to accomplish the work of transferring energy from the heat source to the heat sink. Each heat pump in the thermal heat-reuse system 910 includes the primary components of two heat exchangers (one acting as an evaporator, one acting as a condenser), an expansion device (e.g., valve or fixed orifice), and a compressor (e.g., centrifugal, screw, reciprocating, scroll, or otherwise). Each of these components are fluidly coupled within a closed-loop refrigerant circuit in the heat pump.

The carbon dioxide DAC system 915, generally, operates to pass the ambient airflow input 911 (which includes gaseous carbon dioxide) over or through one or more media (e.g., “filters”). In some aspects, one or more fans (not shown) utilize the power input 908 to circulate the ambient airflow input 911. The media or filter, in some aspects, includes a solid adsorbent to which the atmospheric carbon dioxide in the airflow input 911 bonds. The adsorbent that is saturated with carbon dioxide may be referred to as “rich adsorbent.”

In the case of a solid sorbent, such as the sorbent described in the present disclosure, as the airflow input 911 passes over the solid media or filter, atmospheric carbon dioxide within the input 911 bonds to the media or filter. When the media or filter is saturated with carbon dioxide, it can be heated (e.g., to 100-120° C., to 60-100° C.) to release the carbon dioxide for collection (as described below).

Using thermal energy from the heated fluid 904, heat is applied to the solid adsorbent, which breaks the bonds between the carbon dioxide and the sorbent. The separated carbon dioxide is provided as the carbon dioxide output stream 912 from the carbon dioxide DAC system 915. The now “lean adsorbent” that is carbon dioxide free (i.e., the solid or liquid) is recycled back to capture more carbon dioxide from the ambient airflow input 911. The airflow output 914, typically, contains little to no carbon dioxide. The carbon dioxide DAC system 915 outputs carbon dioxide 912 and demineralized water 916.

As further shown in the example embodiment of FIG. 9, the integrated system 900 includes a power plant 920 (e.g., a natural gas power plant) and a scrubbing system 925 (e.g., a CCS Flue Gas CO₂ scrubbing system). As shown in this example, the power plant 920 may provide waste heat 902 (e.g., as generated through the generation of electrical power by the power plant 920) to the DAC system 915. In this example, the power plant 920 also generates electrical power 922 and 928. In some aspects, as shown, the electrical power 922 goes through one or more switches 930 (shown here as one, but more are possible) to provide electrical power 924 to the DAC system 915 and backup electrical power 926 to the industrial process 905.

As shown in this example, the power output of the power plant 920 may be sized to provide a sum of the electrical power 924 to the DAC system 915 and the electrical power 928 to the scrubbing system 925 for normal operation, as well as the backup electrical power 926 to the industrial process 905 when needed (i.e., when the industrial process 905 loses or cannot use grid electrical power 917). Thus, in some aspects, when the industrial process 905 needs the backup electrical power 926, electrical power 928 and electrical power 924 are still provided to their respective users. Alternatively, in some aspects, the power output of the power plant 920 may be sized to provide a sum of the electrical power 924 to the DAC system 915 and the electrical power 928 to the scrubbing system 925 for normal operation, as well as the backup electrical power 926 to the industrial process 905 when needed (i.e., when the industrial process 905 loses or cannot use grid electrical power 917), as well as one or both of power inputs 906 or 908.

Alternatively, in some aspects, the power output of the power plant 920 may be sized only to provide the backup electrical power 926 to the industrial process 905 when needed (i.e., when the industrial process 905 loses or cannot use grid electrical power 917). Thus, during operational periods when the industrial process 905 does not need backup electrical power 926, the electrical power 928 and/or the electrical power 924 (as well as other power inputs) may be provided by the power plant 920. During operational periods when the industrial process 905 does need backup electrical power 926, the electrical power 928 and/or the electrical power 924 (as well as other power inputs) may not be provided by the power plant 920. For example, electrical power 922 may be routed, in such operational periods, through the switch 930 as backup electrical power 926.

In some aspects, the electrical power 926 supplied from the power plant 920 to the industrial process 905 may not be “backup” power but instead may be a primary power source for the industrial process 905. For example, in some aspects, the power plant 920 may be sized to provide primary electrical power 926 to the industrial process 905, as well as, in some aspects, one or more other components shown in the integrated system 900.

As further shown in FIG. 9, in some aspects, waste heat 902 that is generated from the scrubber system 925 may be used by the thermal heat-reuse plant 910 to provide heated fluid to the DAC system 915. In some implementations, the heated fluid 904 is then returned via heated fluid return 913 to the thermal heat-reuse system 910, and the waste heat 902 is returned to the industrial process 905 via waste heat return 917.

As shown in this example implementation, the scrubbing system 925 also receives an exhaust fluid 932 (e.g., the flue gas with 100% CO₂) from the power plant 920. For example, in some aspects, the power plant 920 may be a natural gas power plant in which natural gas is combusted to drive electrical power generation equipment that operates to generate the electrical power shown in FIG. 9. In other aspects, the power plant 920 may use other carbon-based fuel rather than natural gas. In still other aspects, the power plant 920 may use non-carbon based fuels to generate electrical power (e.g., geothermal, solar, and other). For a natural gas power plant 920, although not shown specifically here, such equipment may include, for example, a compressor rotatably coupled to a gas turbine that drives the compressor. The gas turbine receives combustion products fluid from a combustion chamber that receives compressed natural gas from the compressor. The combustion products fluid drives the gas turbine, which in turn is coupled to and drives a generator to produce electrical power.

Output from such a gas turbine (at a lower pressure than the combustion products fluid) is exhaust fluid 932 (e.g., as a flue gas). A difference in pressure between the combustion products fluid and the exhaust fluid 932 drives the gas turbine to produce electrical power from the generator. As shown in this example, the exhaust fluid 932 is separated by the scrubbing system 925 into multiple output streams. For example, the flue gas with 100% CO₂ 932 is separated into a carbon dioxide output and a flue gas stream 936 with 5% CO₂. The flue gas stream 936 with 5% CO₂ is sent to the DAC system 915 to remove the remaining carbon dioxide from the output airflow of the natural gas plant 920. This makes the resulting power generated from the natural gas plant carbon negative power. For example, similar to the DAC system 915, outputs of a carbon dioxide supply stream 912 and a carbon dioxide-reduced airflow output stream 914 may be output from the scrubbing system 925.

In some aspects, the carbon dioxide supply streams 912 may be sold (e.g., for CO₂-EOR, sequestration, and/or other processes). For example, the carbon dioxide supply streams 912 may generate revenue through emissions credits and federal tax credits. In some aspects, such revenue may offset capital and/or operations costs of the DAC system 915, the power plant 920, both, or other components of the system 900.

The integrated system 900 may advantageously utilize the power plant 920, which may normally be sitting idle, to produce a saleable product in the carbon dioxide fluid streams 912, which also provide environmental benefits. Additionally, in the event of a power outage at the industrial process 905, the power plant 920 would already be running, meaning the delay between the outage and providing the process 905 with power would be reduced. Further, by using the thermal energy 902 from the waste heat 902 from the scrubber 925 and 934, operating costs of the DAC system 915 may be significantly reduced, allowing for the carbon dioxide captured to finance the construction of the DAC system 915 as well as help subsidize the cost of the industrial process's backup power. In addition, the integrated system 900 may produce water from ambient humidity as the DAC system 915 pulls carbon dioxide from the air. The water can be sold or used, e.g., at the industrial process 905.

### EXAMPLES

### Example 1

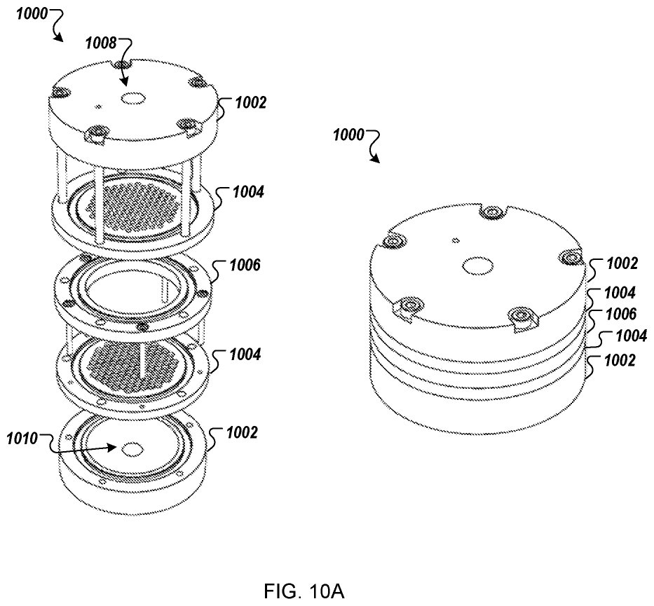

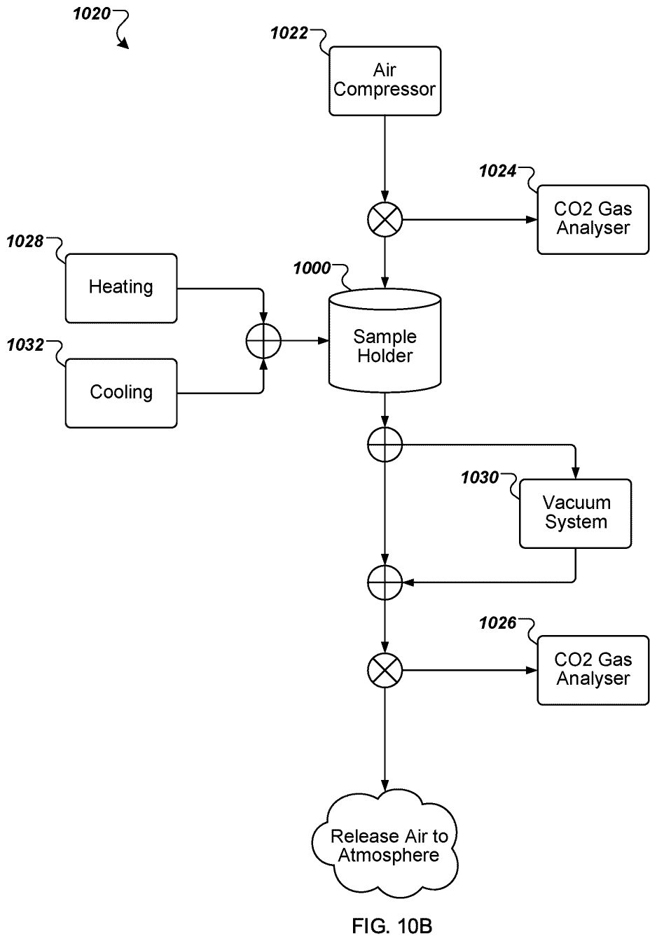

Functionalized silica produced using the process 300 described herein can be characterized by a CO₂ uptake measurement. FIG. 10A schematically illustrates an exploded view (left) and an assembled view (right) of the sample holder 1000 for a sorbent. Functionalized silica particles or granules can be placed in a sample space 1006 arranged between two layers of filter 1004 (e.g., such as glass wool) in a sample holder 1000. The sealing ends 1002 of the sample holder 1000 can include an inlet 1008 and an outlet 1010 permissive to gas flow. The sealing ends 1002 can include reversible screw connections to assemble the sample holder 1000. When assembled (right), the sample holder 1000 can be otherwise sealed against gaseous inflow.

In FIG. 10B, a schematic diagram of the experimental setup 1020 is shown. Referring now to FIGS. 10A and 10B, a gas source, e.g., air compressor 1022, can provide compressed environmental air to the inlet 1008 of a testing sample holder 1000, which can then pass through the filters 1004 and can expose the functionalized silica to environmental air. Air can be exhausted from the outlet 1010. The concentration of CO₂ in the compressed environmental air can be measured by a gas analyzer, e.g., CO₂ gas analyzers 1024 and 1026, prior to entering the inlet 1008 and/or subsequent to exiting the outlet 1010.

The samples of functionalized silica can be treated with an activation process before data collection. Samples can be heated in a vacuum drier (e.g., vacuum heater 1028) to 70° C. for 30 minutes under vacuum (e.g., 0.3 psi) to activate the adsorbent, e.g., as the activation process. Alternatively, and as shown in FIG. 10B, the heating element and the vacuum system 1030 can be separate elements of the setup 1020 and work in concert to heat and apply vacuum to the sample holder 1000. In some implementations, a cooling element 1032 can be included in the setup 1020 to further control the temperature of the environment in the sample holder 1000. The activation process can facilitate removal, e.g., evaporation, of residual solvent medium in the pores of the functionalized silica and can facilitate desorption of CO₂ molecules bonded during a synthesis process 300, 310 for venting to the atmosphere.

For the adsorption procedure, samples of functionalized silica in a range between 0.5 g and 10 g can be placed in between two layers of glass fiber filters 1004 in the testing sample holder 1000. Compressed environmental air (e.g., input air) from gas source 1022 can be continuously fed through the testing sample holder 1000 at a rate 1 to 10 standard liters per minute (slpm), thereby exposing the activated functionalized silica. The activated functionalized silica can be exposed for time periods 30 to 60 minutes. The humidity of the input air can be controlled to be 15% to 50% RH at 21° C. The same sample holder can then be brought to vacuum by vacuum system 1030 and can be heated by vacuum heater 1028 to extract the carbon dioxide from the sample. The amount of carbon dioxide extracted can be measured by gas analyzer 1026.

The humidity can be controlled through blending of “dry air” and “wet air” with a flow meter (not shown). As an example, to produce input air having 50% RH at a flow rate of 5 slpm, dry air (e.g., <10% RH) at 2.5 slpm and wet air (e.g., >95% RH, 100% RH) can be blended at 2.5 slpm each. The dry air and wet air flow control can be done using a closed loop controller.

The compressed environmental air including CO₂ concentration can be monitored by gas analyzers 1024 and 1026 at the input and output of the testing sample holder 1000 during the experimental time period in units of mol CO₂/kg of adsorbent.

### Example 2—Agglomeration Trials

Shown below in Tables 1 and 2 are two trials in which fine particles are agglomerated to a baseline silica to form recycled silica particles. The CO₂ uptake (mol/kg), attrition loss (wt %), crush strength (MPa), and/or bulk density (g/L) determined.

A baseline raw silica product was used as a base for the agglomerated particles. The CO₂ uptake of the baseline raw silica was determined using methods described herein to determine a normalized uptake with which to compare the agglomerated samples.

The agglomerated samples were formed as described herein using the baseline silica. The agglomerated samples of Table 1 were agglomerated using dry roller compaction under a pressure according to the specific row, e.g., either 20 kilopounds per square inch (ksi) or 30 ksi. In the ‘Condition’ column, the term ‘Milled’ means the baseline material was less than 100 microns in size. The term ‘Non-milled’ means the baseline material was up to 500 microns.

Attrition testing was performed on the agglomerated samples. Briefly, 100 g of each sample was placed in a sieve shaker using a 20 mesh screen. The samples were agitated in the shaker for 5 minutes using a tapper. 50 g of the plus 20 mesh product was placed on the mesh 20 screen. 50 pieces of 9.5 mm ceramic beads were added to the 20 mesh screen. The samples were agitated for 5 minutes without the tapper. The weight percentage of fines found in the base pan following the agitation with the ceramic beads was determined compared to the original sample.

Following agglomeration, the samples were coated with the functionalization mixture and tested for CO₂ uptake, both methods as described herein. Briefly, for the functionalization/coating process, 7.7 wt % of PEI and 36 wt % of DAMO in 160 wt % of water were added to 100 g of the silica substrate by dip coating in the PEI/DAMO/Water solution. After the dip coating, the samples are dried under vacuum @ 70° C. for 24 hrs. Then the samples are tested with the method described in Example 1 to determine the uptake performance.

TABLE 1

| | | | Uptake | |
|---|---|---|---|---|
| Trial 1 | Condition | Shape | (mol/kg) | Attrition |
| Baseline | Not from agglomeration | Spherical | 1.2 | 8.7% |
| Silica | | granules | | |
| BT1 Run1 | silica150A no-milled | Flat chips | 1.14 | 30.5% |
| | 20 ksi (70-200 um) | | | |
| BT1 Run2 | silica 150A milled 20 ksi | Flat chips | 0.67 | 6.9% |
| BT1 Run3 | silica 150A milled 30 ksi | Flat chips | 0.53 | 7.7% |
| BT1 Run4 | silica F1 milled 20 ksi | Flat chips | 0.64 | 11.3% |

The agglomerated samples for Table 2 (below) were produced using a liquid binding mixture of PVA and water at varying wt % (PVA to water wt %) as a binder. The samples from Table 2 were agglomerated using a mixer with the liquid binding mixture. The CO₂ uptake capacity and attrition were determined as the samples for Table 1.

The agglomerated particles for Table 2 were characterized for compression strength. The bulk compression strength test utilizes a test fixture which consists of a lower crush platform and upper crusher head. The lower crush platform includes a flat surface onto which samples are placed. The upper crush head includes a crush head with a flat lower surface substantially parallel with the plane of surface such that force is applied evenly to particles between the crush head and surface during force application. The crush head has an outer diameter (OD) 72.6 mm and the surface was 124.5 mm in diameter. The crush platform has a diameter 125.4 mm. In another example, the crush platform has a diameter of 146 mm.

During testing, a layer of particles, e.g., the sample, are packed closely on the crush platform and roughly aligned with the center of the crush head. The particle bed diameter is about 90 mm to about 2 mm in thickness. The samples were 3-6 g dry weight depending on particle coating components. The force applied to the crush head was recorded while displacement changed. The packed particle bed was crushed to achieve 50% of its compressive strain (e.g., displacement divided by initial sample bed thickness) and the stress (MPa) (e.g., force divided by contact area) is reported as 50% strain crush strength. Samples of uncoated, and coated particles were tested. For both types of particle, at least 3 samples are tested to get the average performance for the bulk compression strength.

The bulk density is measured according to ASTM D1895 Method A. Briefly, fine granules were poured through a V shaped funnel. The material being tested were allowed to flow into a cylinder cup with a known volume of 100 mL. Testing results were averaged using more than 4 measurements.

TABLE 2

| | | | | | Crush | Bulk |
|---|---|---|---|---|---|---|
| | | | Uptake | | Strength | Density |
| Trial 2 | Condition | Shape | (mol/kg) | Attrition | (MPa) | (g/L) |
| Baseline Silica | Not from agglomeration | Spherical | 1.2 | 12% | 1.14 | 260 |
| BT2 Run1 | 7% PVA solution as binder | granules | 1.35 | 5-7 wt % | 1.04 | 262 |
| BT2 Run2 | 10% PVA solution as binder | | 1.3 | 5-7 wt % | 1.21 | 268 |
| BT2 Run3 | 3% PVA solution as binder | | 1.35 | 5-7 wt % | 0.87 | 255 |

A number of implementations have been described. Nevertheless, it will be understood that various modifications may be made without departing from the spirit and scope of the invention. Accordingly, other implementations are within the scope of the following claims.

What is claimed is:

1. A functionalized granule comprising:
a plurality of fine particles, wherein at least one of the plurality of fine particles comprises a first porous silica, a first silane moiety bound to a surface of the first porous silica, and a first amine moiety bound to the first silane moiety; and
a coating disposed on at least a portion of a surface of at least one of the plurality of fine particles, wherein the coating comprises an optional second silane moiety and a second amine moiety, and optionally wherein the coating is configured to bind the plurality of fine particles.

2. The functionalized granule of claim 1, wherein the plurality of fine particles has an average dimension or a mean dimension (e.g., diameter) of about 25 microns to about 500 microns.

3. The functionalized granule of claim 1 or 2, wherein at least one fine particle of the plurality of fine particles comprises a plurality of pores.

4. The functionalized granule of claim 3, wherein the plurality of pores has an average dimension or a mean dimension (e.g., diameter) of about 60 angstroms to about 600 angstroms.

5. The functionalized granule of any one of claims 1-4, wherein the coating comprises the second silane moiety, and wherein the second amine moiety is bound to the second silane moiety.

6. The functionalized granule of any one of claims 1-5, wherein the coating further comprises a polymer.

7. The functionalized granule of claim 6, wherein the polymer comprises a polymeric amine.

8. The functionalized granule of any one of claims 1-7, wherein the coating is disposed on surfaces of the plurality of fine particles.

9. The functionalized granule of any one of claims 1-8, further comprising a matrix disposed between at least a portion of the plurality of fine particles, wherein the matrix comprises the second silane moiety and the second amine moiety.

10. The functionalized granule of any one of claims 1-9, wherein the functionalized granule has an average dimension or a mean dimension (e.g., diameter) of about 500 microns to about 2 millimeters.

11. The functionalized granule of any one of claims 1-10, wherein the functionalized granule comprises a plurality of pores.

12. The functionalized granule of any one of claims 1-11, wherein the functionalized granule is characterized by a bulk density of about 10 lb/ft³ to about 4 lb/ft³ (e.g., about 15 lb/ft³, about 30 lb/ft³), an average pore size of about 60 angstroms to about 600 angstroms, a crush strength (e.g., the stress at 50% compression strain) in range of about 1 MPa to about 4 MPa, an attrition loss percentage according to ASTM D4058 testing (e.g., loss as measured from about the 30 mins duration at about 60 rpm tumble rate) of 0 wt % to about 4 wt % (e.g., about 1.5 wt %, or about 3 wt %) and/or a pore volume of about 0.1 mL/g to about 2.0 mL/g (e.g., about 0.5 mL/g, or about 1.5 mL/g).

13. A method, comprising:
collecting a plurality of fine particles, wherein at least one of the plurality of fine particles comprises a first porous silica, a first silane moiety bound to a surface of the first porous silica, and a first amine moiety bound to the first silane moiety; and
generating a plurality of functionalized granules using the plurality of fine particles, wherein an average dimension or a mean dimension (e.g., diameter) of the plurality of functionalized granules is larger than an average dimension or a mean dimension (e.g., diameter) of the plurality of fine particles, and
optionally wherein at least one of the plurality of functionalized granules comprises a second porous silica, a second silane moiety bound to the surface of the second porous silica, and a second amine moiety bound to the second silane moiety.

14. The method of claim 13, wherein said generating comprises:
agglomerating the plurality of fine particles to provide a plurality of granules; and
forming a coating on at least a portion of a surface of at least one of the plurality of granules and/or a matrix between at least a portion of the plurality of fine particles or between at least a portion of the plurality of granules, thereby generating the plurality of functionalized granules, wherein the coating and/or the matrix comprises the second silane moiety bound to the surface of at least one granule and the second amine moiety bound to the second silane moiety.

15. The method of claim 13, wherein said generating comprises:
forming a coating on at least a portion of a surface of at least one of the plurality of fine particles and/or a matrix between at least a portion of the plurality of fine particles, thereby providing a plurality of functionalized fine particles, wherein the coating comprises the second silane moiety bound to the surface of at least one fine particle and the second amine moiety bound to the second silane moiety; and
agglomerating the plurality of functionalized fine particles, thereby generating the plurality of functionalized granules.

16. The method of any one of claims 13-15, wherein said generating comprises:
exposing the plurality of fine particles, the plurality of granules (if present), or the plurality of functionalized fine particles (if present), to a liquid binder.

17. The method of claim 16, wherein said exposing comprises providing or adjusting a tip speed, a moisture content, an addition rate of the liquid binder, a mixing time, and/or a temperature to provide sufficient agglomeration of the plurality of fine particles, the plurality of granules (if present), or the plurality of functionalized fine particles (if present).

18. The method of any one of claims 13-17, wherein said generating comprises:
spraying the plurality of fine particles, the plurality of granules (if present), or the plurality of functionalized fine particles (if present), with a liquid binder.

19. The method of any one of claims 16-18, wherein the liquid binder comprises water, a solvent, a silane, an aminosilane, the second silane moiety, the second amine moiety, the second amine moiety bound to the second silane moiety, and/or a polymeric amine.

20. The method of any one of claims 13-19, wherein said generating comprises:
applying shear to the plurality of fine particles, the plurality of granules (if present), or the plurality of functionalized fine particles (if present).

21. The method of claim 20, wherein the shear is provided by way of a pin mixer, a paddle mixer, and/or a ribbon blender.

22. The method of any one of claims 13-21, wherein said collecting comprises obtaining the plurality of fine particles from an inlet to a reactor comprising a powdered adsorbent material or an outlet from a reactor comprising a powdered adsorbent material (e.g., an adsorption reactor, a desorption reactor, or another reactor).

23. The method of claim 22, wherein the powdered adsorbent material comprises the first porous silica, the first silane moiety bound to a surface of the first porous silica, and/or the first amine moiety bound to the first silane moiety.

24. The method of any one of claims 13-23, wherein the second porous silica of at least one of the plurality of functionalized granules comprises the first porous silica of at least one of the plurality of fine particles.

25. The method of any one of claims 13-24, wherein at least one functionalized granule of the plurality of functionalized granules comprises the functionalized granule of any one of claims 1-12.

26. The method of any one of claims 13-25, further comprising:
drying said plurality of functionalized granules (e.g., in a vacuum oven at 80° C. until a hydration threshold of less than 5% wt/wt of water to coated silica substrate is reached).

27. A direct air capture (DAC) system comprising:
a first inlet configured to receive a first powdered adsorbent material;
a second inlet configured to receive a recycled powdered adsorbent material obtained by recycling at least a portion of the first powdered adsorbent material;
an adsorber system configured to adsorb CO₂ from ambient air using the first powdered adsorbent material and the recycled powdered adsorbent material;
a desorber system configured desorb to CO₂ from the first powdered adsorbent material and the recycled powdered adsorbent material; and
an outlet configured to deliver a plurality of fine particles from a volume of air passaged into, through, or out of the adsorber system.

28. The system of claim 27, wherein the first powdered adsorbent material comprises a plurality of first functionalized granules, wherein at least one of the plurality of first functionalized granules comprises a first porous silica, a first silane moiety bound to a surface of the first porous silica, and a first amine moiety bound to the first silane moiety.

29. The system of claim 27 or 28, wherein at least one of the plurality of fine particles comprises the first porous silica, the first silane moiety bound to a surface of the first porous silica, and/or the first amine moiety bound to the first silane moiety from at least one of the plurality of first functionalized granules.

30. The system of any one of claims 27-29, wherein the recycled powdered adsorbent material comprises a plurality of second functionalized granules, wherein at least one of the plurality of second functionalized granules comprises a second porous silica, a second silane moiety bound to the surface of the second porous silica, and a second amine moiety bound to the second silane moiety.

31. The system of claim 30, wherein the second porous silica of at least one of the plurality of second functionalized granules comprises the first porous silica of at least one of the plurality of fine particles or the first porous silica of at least one of the plurality of first functionalized granules.

32. The system of any one of claims 27-32, wherein at least one of the plurality of second functionalized granules comprises the functionalized granule of any one of claims 1-12.

33. The system of any one of claims 27-32, further comprising:
one or more blowers each arranged to receive ambient air and blow air into the adsorber system; and
one or more exhaust ports each configured to remove air from the adsorber system and/or the desorber system.

34. The system of claim 33, wherein the outlet is in fluidic communication with at least one of the one or more exhaust ports.

35. An agglomeration system comprising:
a first inlet configured to receive a plurality of fine particles, wherein at least one of the plurality of fine particles comprises a first porous silica, a first silane moiety bound to a surface of the first porous silica, and a first amine moiety bound to the first silane moiety;
a second inlet configured to a liquid binder;
a reactor configured to generate a plurality of functionalized granules using the plurality of fine particles, wherein an average dimension or a mean dimension (e.g., diameter) of the plurality of functionalized granules is larger than an average dimension or a mean dimension (e.g., diameter) of the plurality of fine particles; and
an outlet configured to deliver the plurality of functionalized granules out of the reactor.

36. The system of claim 35, wherein at least one of the plurality of functionalized granules comprises a second porous silica, a second silane moiety bound to the surface of the second porous silica, and a second amine moiety bound to the second silane moiety.

37. The system of claim 36, wherein the second porous silica of at least one of the plurality of functionalized granules comprises the first porous silica of at least one of the plurality of fine particles.

38. The system of any one of claims 35-37, wherein at least one of the plurality of functionalized granules comprises the functionalized granule of any one of claims 1-12.

39. The system of any one of claims 35-38, wherein said reactor comprises: a liquid handler (e.g., a sprayer) configured to expose the plurality of fine particles to a liquid binder.

40. The system of claim 39, wherein the liquid binder comprises water, a solvent, a silane, an aminosilane, the second silane moiety, the second amine moiety, the second amine moiety bound to the second silane moiety, and/or a polymeric amine.

41. The system of any one of claims 35-40, wherein said reactor comprises: a mixer configured to apply shear to the plurality of fine particles.

42. The system of claim 41, wherein the mixer comprises a pin mixer, a paddle mixer, and/or a ribbon blender.

43. A method of making calcined particles, the method comprising:
collecting a plurality of depleted functionalized particles, wherein the plurality of depleted functionalized particles comprises a porous silica, a silane moiety bound to a surface of the porous silica, and an amine moiety bound to the silane moiety; and
heating the plurality of depleted functionalized particles to a temperature sufficient to thermally decompose the silane moiety and the amine moiety to generate a plurality of calcined particles.

44. The method of claim 43, wherein the plurality of depleted functionalized particles has a CO₂ uptake capacity of less than 0.5 mol CO₂/kg.

45. The method of claim 43 or 44, wherein the temperature is sufficient to prevent crystallization of the plurality of depleted functionalized particles.

46. The method of any one of claims 43 to 45, comprising maintaining the temperature for a duration sufficient to thermally decompose the silane moiety and the amine moiety.

47. The method of claim 46, comprising cooling, after the duration, the calcined particles at a rate sufficient to prevent crystallization of the calcined particles.

48. The method of claim 47, wherein the heating, the cooling, or both, are independently performed for a duration that is no more than one hour each.

49. The method of any one of claims 43 to 46, comprising providing at least a portion of the calcined particles as the plurality of fine particles in the method of claim 1 or 13.

50. A method, comprising:
collecting a plurality of depleted functionalized particles, wherein the plurality of depleted functionalized particles comprises a porous silica, a silane moiety bound to a surface of the porous silica, and an amine moiety bound to the silane moiety; and
exposing the plurality of depleted functionalized particles to a pacification agent such that a plurality of depleted functionalized particles are no longer reactive.

51. The method of claim 50, wherein exposing comprises exposing the plurality of depleted functionalized particles to a reducing agent which chemically reduces the amine moiety.

52. The method of claim 50, wherein exposing comprises exposing the plurality of depleted functionalized particles to an oxidizing agent which chemically oxidizes the amine moiety and the silane moiety.

53. The method of claim 50, wherein exposing comprises exposing the plurality of depleted functionalized particles to a conversion agent such that the amine moiety is converted to a nitrogen source.

54. The method of claim 53, wherein the nitrogen source is a urea-containing nitrogen source.

55. The method of claim 53, wherein the conversion agent is carbon dioxide or formaldehyde.

56. The method of claim 53, comprising drying, before exposing, the plurality of depleted functionalized particles to a moisture content of 5% wt/wt or less.

57. The method of claim 50, wherein exposing comprises exposing the plurality of depleted functionalized particles to one or more polar solvents sufficient to remove the amine moiety and the silane moiety from the porous silica.

58. The method of claim 50, wherein exposing comprises exposing the plurality of depleted functionalized particles to a first aqueous solution of about pH 2 or less, and a second aqueous solution of pH 12 or greater, wherein the pH is sufficient to remove the amine moiety and the silane moiety from the porous silica.

59. The method of any one of claims 50-56, comprising providing at least a portion of the porous silica as the plurality of fine particles in the method of claim 1 or 13.
